(19) United States
(12) Patent Application Publication
(10) Pub. No.: US 2024/0306053 A1
(43) Pub. Date: Sep. 12, 2024

(54) TERMINAL, RADIO COMMUNICATION METHOD, AND BASE STATION

(71) Applicant: NTT DOCOMO, INC., Tokyo (JP)

(72) Inventors: Yuki Matsumura, Tokyo (JP); Satoshi Nagata, Tokyo (JP); Jing Wang, Beijing (CN); Lan Chen, Beijing (CN)

(73) Assignee: NTT DOCOMO, INC., Tokyo (JP)

(21) Appl. No.: 18/575,028

(22) PCT Filed: Jul. 2, 2021
(86) PCT No.: PCT/JP2021/025064

§ 371 Date: Dec. 28, 2023

(51) Int. Cl. H04W 36/00; H04L 5/00

(52) U.S. Cl. CPC H04W 36/0072; H04L 5/0094

(57) ABSTRACT

A terminal according to one aspect of the present disclosure includes a receiving section that receives information for indicating at least one of a first Transmission Configuration Indication state (TCI) state common to both downlink (DL) and uplink (UL), a second TCI state common to the DL, and a third TCI state common to the UL, the first TCI state, the second TCI state, and the third TCI state being associated with a certain cell that is other than a serving cell and has a physical cell ID different from a physical cell ID of the serving cell, and a control section that applies, to a specific channel for the certain cell, at least one of the first TCI state, the second TCI state, and the third TCI state indicated in the information. According to one aspect of the present disclosure, it is possible to appropriately perform transmission/reception to/from another cell having a physical cell ID different from a physical cell ID of a serving cell.

### TECHNICAL FIELD

The present disclosure relates to a terminal, a radio communication method, and a base station in next-generation mobile communication systems.

### BACKGROUND ART

In a Universal Mobile Telecommunications System (UMTS) network, the specifications of Long-Term Evolution (LTE) have been drafted for the purpose of further increasing high speed data rates, providing lower latency and so on (see Non-Patent Literature 1). In addition, for the purpose of further high capacity, advancement and the like of the LTE (Third Generation Partnership Project (3GPP) Release (Rel.) 8 and Rel. 9), the specifications of LTE-Advanced (3GPP Rel. 10 to Rel. 14) have been drafted.

Successor systems of LTE (for example, also referred to as “5th generation mobile communication system (5G),” “5G+ (plus),” “6th generation mobile communication system (6G),” “New Radio (NR),” “3GPP Rel. 15 (or later versions),” and so on) are also under study.

### CITATION LIST

### Non-Patent Literature

Non-Patent Literature 1: 3GPP TS 36.300 V8.12.0 “Evolved Universal Terrestrial Radio Access (E-UTRA) and Evolved Universal Terrestrial Radio Access Network (E-UTRAN); Overall description; Stage 2 (Release 8),” April, 2010

### SUMMARY OF INVENTION

### Technical Problem

For future radio communication systems, layer 1/layer 2 (L1/L2) inter-cell mobility for achieving more efficient DL/UL beam management (for achieving lower latency and overhead) is under study.

However, in a case where the inter-cell mobility including another cell (non-serving cell) having a physical cell ID different from a physical cell ID of a serving cell is applied, processing in a case where transmission/reception to/from such another cell is performed remains indefinite. Therefore, appropriate transmission/reception to/from such another cell fails, and throughput reduction or communication quality degradation may occur.

Thus, an object of the present disclosure is to provide a terminal, a radio communication method, and a base station that can appropriately perform transmission/reception to/from another cell having a physical cell ID different from a physical cell ID of a serving cell.

### Solution to Problem

A terminal according to one aspect of the present disclosure includes a receiving section that receives information for indicating at least one of a first Transmission Configuration Indication state (TCI) state common to both downlink (DL) and uplink (UL), a second TCI state common to the DL, and a third TCI state common to the UL, the first TCI state, the second TCI state, and the third TCI state being associated with a certain cell that is other than a serving cell and has a physical cell ID different from a physical cell ID of the serving cell, and a control section that applies, to a specific channel for the certain cell, at least one of the first TCI state, the second TCI state, and the third TCI state indicated in the information.

### Advantageous Effects of Invention

According to one aspect of the present disclosure, it is possible to appropriately perform transmission/reception to/from another cell having a physical cell ID different from a physical cell ID of a serving cell.

### BRIEF DESCRIPTION OF DRAWINGS

FIGS. 1A and 1B are each a diagram to show an example of a common beam.

FIG. 2A shows an example of inter-cell mobility including a non-serving cell, and FIG. 2B shows an example of a multi-TRP scenario.

FIGS. 3A and 3B are each a diagram to show a first example of a MAC CE.

FIGS. 4A and 4B are each a diagram to show a second example of the MAC CE.

FIG. 5 is a diagram to show an example of a schematic structure of a radio communication system according to one embodiment.

FIG. 6 is a diagram to show an example of a structure of a base station according to one embodiment.

FIG. 7 is a diagram to show an example of a structure of a user terminal according to one embodiment.

FIG. 8 is a diagram to show an example of a hardware structure of the base station and the user terminal according to one embodiment.

### DESCRIPTION OF EMBODIMENTS

### (CSI Reporting)

In NR, a UE measures a channel state by using a certain reference signal (or resource for the reference signal), and feeds back (reports) channel state information (CSI) to a base station.

The UE may measure the channel state by using a channel state information reference signal (CSI-RS), a synchronization signal/broadcast channel (Synchronization Signal/Physical Broadcast Channel (SS/PBCH)) block, a synchronization signal (SS), a demodulation reference signal (DMRS), or the like.

A CSI-RS resource may include at least one of a non-zero power (NZP) CSI-RS and CSI-Interference Management (IM). The SS/PBCH block is a block including a synchronization signal (for example, a primary synchronization signal (PSS)), a secondary synchronization signal (SSS), and a PBCH (and a corresponding DMRS), and may be referred to as an SS block (SSB) or the like. An SSB index may be given to a temporal location of the SSB in a half frame.

Note that the CSI may include at least one of a channel quality indicator (CQI), a precoding matrix indicator (PMI), a CSI-RS resource indicator (CRI), an SS/PBCH block resource indicator (SSBRI), a layer indicator (LI), a rank indicator (RI), Layer 1 (L1)-Reference Signal Received Power (RSRP) (reference signal received power in Layer 1), L1-Reference Signal Received Quality (RSRQ), an L1-Signal to Interference plus Noise Ratio (SINR), an L1-Signal to Noise Ratio (SNR), and the like.

The CSI may have a plurality of parts. A first part of the CSI (CSI part 1) may include information with a relatively small number of bits (for example, the RI). A second part of the CSI (CSI part 2) may include information with a relatively large number of bits (for example, the COI), such as information determined on the basis of CSI part 1.

As a method for feeding back the CSI, (1) periodic CSI (P-CSI) reporting, (2) aperiodic CSI (A (AP)-CSI) reporting, (3) semi-persistent (semi-permanent) CSI reporting (SP-CSI) reporting, and the like are under study.

Information related to CSI reporting (which may be referred to as CSI report configuration information) may be notified to the UE by using higher layer signaling, physical layer signaling (for example, downlink control information (DCI)), or a combination of these. The CSI report configuration information may be configured by using, for example, an RRC information element “CSI-ReportConfig.”

Here, the higher layer signaling may be, for example, any one or combinations of Radio Resource Control (RRC) signaling, Medium Access Control (MAC) signaling, broadcast information, and the like.

The MAC signaling may use, for example, a MAC control element (MAC CE), a MAC Protocol Data Unit (MAC PDU), or the like. The broadcast information may be, for example, a master information block (MIB), a system information block (SIB), minimum system information (Remaining Minimum System Information (RMSI)), other system information (OSI), or the like.

For example, the CSI report configuration information may include information related to a report periodicity, offset, and the like, and these may be represented by certain time units (slot units, subframe units, symbol units, or the like). The CSI report configuration information may include a configuration ID (CSI-ReportConfigId). Parameters, such as a type of CSI reporting method (whether the type is SP-CSI or not, or the like) and a report periodicity, may be identified by the configuration ID. The CSI report configuration information may include information (CSI-ResourceConfigId) indicating which signal (or which signal resource) measured CSI is reported with.

### (Beam Management)

For Rel-15 NR thus far, a beam management (BM) method has been studied. In the beam management, beam selection based on L1-RSRP reported by the UE is under study. Changing (switching) a beam of a certain signal/channel may correspond to changing a transmission configuration indication state (TCI state) for the signal/channel.

Note that a beam selected by the beam selection may be a transmit beam (Tx beam), or may be a receive beam (Rx beam). The beam selected by the beam selection may be a UE beam, or may be a base station beam.

The UE may report (transmit) a measurement result for the beam management by using a PUCCH or a PUSCH. The measurement result may be, for example, CSI including at least one of L1-RSRP, L1-RSRQ, L1-SINR, L1-SNR, and the like. The measurement result may be referred to as beam measurement, a beam measurement result, a beam report, a beam measurement report, or the like.

CSI measurement for the beam report may include interference measurement. The UE may measure channel quality, interference, and the like by using a CSI measurement resource to derive the beam report. The CSI measurement resource may be, for example, at least one of an SS/PBCH block resource, a CSI-RS resource, another reference signal resource, and the like. Configuration information about reporting of the CSI measurement may be configured for the UE by using higher layer signaling.

The beam report may include a result of at least one of channel quality measurement and interference measurement. The result of the channel quality measurement may include, for example, L1-RSRP. The result of the interference measurement may include L1-SINR, L1-SNR, L1-RSRQ, another interference-related indicator (for example, an arbitrary indicator other than the L1-RSRP), and the like.

Note that the CSI measurement resource for the beam management may be referred to as a beam measurement resource. A signal/channel as a target for the CSI measurement may be referred to as a beam measurement signal. The CSI measurement/reporting may be interpreted as at least one of measurement/reporting for beam management, beam measurement/reporting, radio link quality measurement/reporting, and the like.

CSI report configuration information with consideration of beam management in existing NR is included in the RRC information element “CSI-ReportConfig.” Information in the RRC information element “CSI-ReportConfig” will be described.

The CSI report configuration information (CSI-ReportConfig) may include report quantity information (which may be represented by “report quantity” or an RRC parameter “reportQuantity”) that is information about parameters to be reported. The report quantity information is defined by an ASN.1 object type “choice type (choice).” Thus, one of the parameters (cri-RSRP, ssb-Index-RSRP, and the like) defined as the report quantity information is configured.

For each report configuration, the UE for which a higher layer parameter (for example, an RRC parameter “groupBasedBeamReporting”) included in the CSI report configuration information is set to “enabled” may include, in a beam report, a plurality of beam measurement resource IDs (for example, SSBRIs or CRIs) and a plurality of measurement results (for example, L1-RSRP) corresponding to these.

For each report configuration, the UE for which the number of report target RS resources being one or more is configured by a higher layer parameter (for example, an RRC parameter “nrofReportedRS”) included in the CSI report configuration information may include, in a beam report, one or more beam measurement resource IDs and one or more measurement results (for example, L1-RSRP) corresponding to these.

### (TCI, Spatial Relation, QCL)

For NR, control of reception processing (for example, at least one of reception, demapping, demodulation, and decoding) and transmission processing (for example, at least one of transmission, mapping, precoding, modulation, and coding) in a UE regarding at least one of a signal and a channel (which is expressed as a signal/channel) based on a transmission configuration indication state (TCI state) is under study.

The TCI state may be a state applied to a downlink signal/channel. A state that corresponds to the TCI state applied to an uplink signal/channel may be expressed as spatial relation.

The TCI state is information related to quasi-co-location (QCL) of the signal/channel, and may be referred to as a spatial reception parameter, spatial relation information, or the like. The TCI state may be configured for the UE for each channel or for each signal.

QCL is an indicator indicating statistical properties of the signal/channel. For example, when a certain signal/channel and another signal/channel are in a relationship of QCL, it may be indicated that it is assumable that at least one of Doppler shift, a Doppler spread, an average delay, a delay spread, and a spatial parameter (for example, a spatial reception parameter (spatial Rx parameter)) is the same (the relationship of QCL is satisfied in at least one of these) between such a plurality of different signals/channels.

Note that the spatial reception parameter may correspond to a receive beam of the UE (for example, a receive analog beam), and the beam may be identified based on spatial QCL. The QCL (or at least one element in the relationship of QCL) in the present disclosure may be interpreted as sQCL (spatial QCL).

For the QCL, a plurality of types (QCL types) may be defined. For example, four QCL types A to D may be provided, which have different parameter(s) (or parameter set (s)) that can be assumed to be the same, and such parameter (s) (which may be referred to as QCL parameter (s)) are described below:
QCL type A (QCL-A): Doppler shift, Doppler spread, average delay, and delay spread
QCL type B (QCL-B): Doppler shift and Doppler spread
QCL type C (QCL-C): Doppler shift and average delay
QCL type D (QCL-D): Spatial reception parameter

A case that the UE assumes that a certain control resource set (CORESET), channel, or reference signal is in a relationship of specific QCL (for example, QCL type D) with another CORESET, channel, or reference signal may be referred to as QCL assumption.

The UE may determine at least one of a transmit beam (Tx beam) and a receive beam (Rx beam) of the signal/channel, based on the TCI state or the QCL assumption of the signal/channel.

The TCI state may be, for example, information related to QCL between a channel as a target (in other words, a reference signal (RS) for the channel) and another signal (for example, another RS). The TCI state may be configured (indicated) by higher layer signaling or physical layer signaling, or a combination of these.

A channel for which the TCI state or spatial relation is configured (specified) may be, for example, at least one of a downlink shared channel (Physical Downlink Shared Channel (PDSCH)), a downlink control channel (Physical Downlink Control Channel (PDCCH)), an uplink shared channel (Physical Uplink Shared Channel (PUSCH)), and an uplink control channel (Physical Uplink Control Channel (PUCCH)).

The RS to have a QCL relationship with the channel may be, for example, at least one of a synchronization signal block (SSB), a channel state information reference signal (CSI-RS), a reference signal for measurement (Sounding Reference Signal (SRS)), a CSI-RS for tracking (also referred to as a Tracking Reference Signal (TRS)), and a reference signal for QCL detection (also referred to as a QRS).

The SSB is a signal block including at least one of a primary synchronization signal (PSS), a secondary synchronization signal (SSS), and a broadcast channel (Physical Broadcast Channel (PBCH)). The SSB may be referred to as an SS/PBCH block.

An information element of the TCI state (“TCI-state IE” of RRC) configured using higher layer signaling may include one or a plurality of pieces of QCL information (“QCL-Info”). The QCL information may include at least one of information related to an RS to have a QCL relationship (RS relation information) and information indicating a QCL type (QCL type information). The RS relation information may include information such as an index of the RS (for example, an SSB index, or a non-zero power CSI-RS (NZP CSI-RS) resource ID (Identifier)), an index of a cell in which the RS is located, and an index of a Bandwidth Part (BWP) in which the RS is located.

In Rel-15 NR, as a TCI state for at least one of the PDCCH and the PDSCH, both a QCL type A RS and a QCL type D RS or only the QCL type A RS can be configured for the UE.

When the TRS is configured as the QCL type A RS, it is assumed that the TRS is different from a demodulation reference signal (DMRS) of the PDCCH or PDSCH and that the same TRS is periodically transmitted for a long time. The UE can calculate an average delay, a delay spread, and the like by measuring the TRS.

The UE for which the TRS is configured as the QCL type A RS in a TCI state for the DMRS of the PDCCH or PDSCH can assume that QCL type A parameters (an average delay, a delay spread, and the like) of the TRS are the same as those of the DMRS of the PDCCH or PDSCH, and thus can compute type A parameters (an average delay, a delay spread, and the like) of the DMRS of the PDCCH or PDSCH on the basis of a measurement result of the TRS. The UE can, when performing channel estimation of at least one of the PDCCH and the PDSCH, perform the channel estimation with higher accuracy by using the measurement result of the TRS.

The UE for which the QCL type D RS is configured can determine a UE receive beam (spatial domain reception filter, UE spatial domain reception filter) by using the QCL type D RS.

A QCL type X RS in a TCI state may mean an RS in a relationship of QCL type X with (a DMRS of) a certain channel/signal, and this RS may be referred to as a QCL source of QCL type X in the TCI state.

### (Unified/Common TCI Framework)

According to a unified TCI framework, UL and DL channels can be controlled by a common framework. Instead of defining a TCI state or a spatial relation for each channel in a manner similar to that of Rel. 15, the unified TCI framework may indicate a common TCI state (common beam) and apply the common TCI state to all UL and DL channels, or may apply a UL common TCI state to all UL channels and apply a DL common TCI state to all DL channels.

One common TCI state for both DL and UL or a DL common TCI state and a UL common TCI state (two common TCI states in total) are under study.

The UE may assume the same TCI state (joint TCI state, joint TCI pool, joint common TCI pool, joint TCI state set) for the UL and DL. The UE may assume different TCI states (separate TCI states, separate TCI pools, UL separate TCI pool and DL separate TCI pool, separate common TCI pool, UL common TCI pool and DL common TCI pool) for respective ones of the UL and DL.

Default beams for the UL and DL may be unified by MAC CE-based beam management (MAC CE-level beam indication). The default beams may be unified with a default UL beam (spatial relation) by updating a default TCI state for the PDSCH.

A common beam/unified TCI state from the same TCI pool (joint common TCI pool, joint TCI pool, set) for both of the UL and DL may be indicated by DCI-based beam management (DCI-level beam indication). X (>1) TCI states may be activated by the MAC CE. UL/DL DCI may select one TCI state from X active TCI states. The selected TCI state may be applied to channels/RSs for both of the UL and DL.

The TCI pool (set) may be a plurality of TCI states configured by an RRC parameter, or may be a plurality of TCI states (active TCI states, active TCI pools, sets) activated by the MAC CE, out of a plurality of TCI states configured by the RRC parameter. Each TCI state may be a QCL type A/D RS. As the QCL type A/D RS, an SSB, a CSI-RS, or an SRS may be configured.

The number of TCI states corresponding to each of one or more TRPs may be defined. For example, the number N (≥1) of TCI states (UL TCI states) applied to a UL channel/RS and the number M (≥1) of TCI states (DL TCI states) applied to a DL channel/RS may be defined. At least one of N and M may be notified/configured/indicated for the UE via higher layer signaling/physical layer signaling.

In the present disclosure, description “N=M=X (X is an arbitrary integer)” may mean that X TCI states (joint TCI states) (corresponding to X TRPs) common to the UL and DL are notified/configured/indicated for the UE. Also, description “N=X (X is an arbitrary integer), M=Y (Y is an arbitrary integer, Y may be equal to X)” may mean that respective ones of X UL TCI states (corresponding to X TRPs) and Y DL TCI states (corresponding to Y TRPs) (in other words, separate TCI states) are notified/configured/indicated for the UE.

For example, description “N=M=1” may mean that one TCI state common to the UL and DL is notified/configured/indicated for the UE, the TCI state being for a single TRP (joint TCI state for a single TRP).

For example, description “N=1, M=1” may mean that one UL TCI state and one DL TCI state for a single TRP are separately notified/configured/indicated for the UE (separate TCI state for a single TRP).

For example, description “N=M=2” may mean that a plurality of (two) TCI states common to the UL and DL are notified/configured/indicated for the UE, the plurality of TCI states being for a plurality of (two) TRPs (joint TCI states for multiple TRPs).

For example, description “N=2, M=2” may mean that a plurality of (two) UL TCI states and a plurality of (two) DL TCI states for a plurality of (two) TRPs are notified/configured/indicated for the UE (separate TCI states for multiple TRPs).

Note that in the above-described examples, cases where values of N and M are 1 or 2 are described, but the values of N and M may be 3 or more, and N and M may be different from each other.

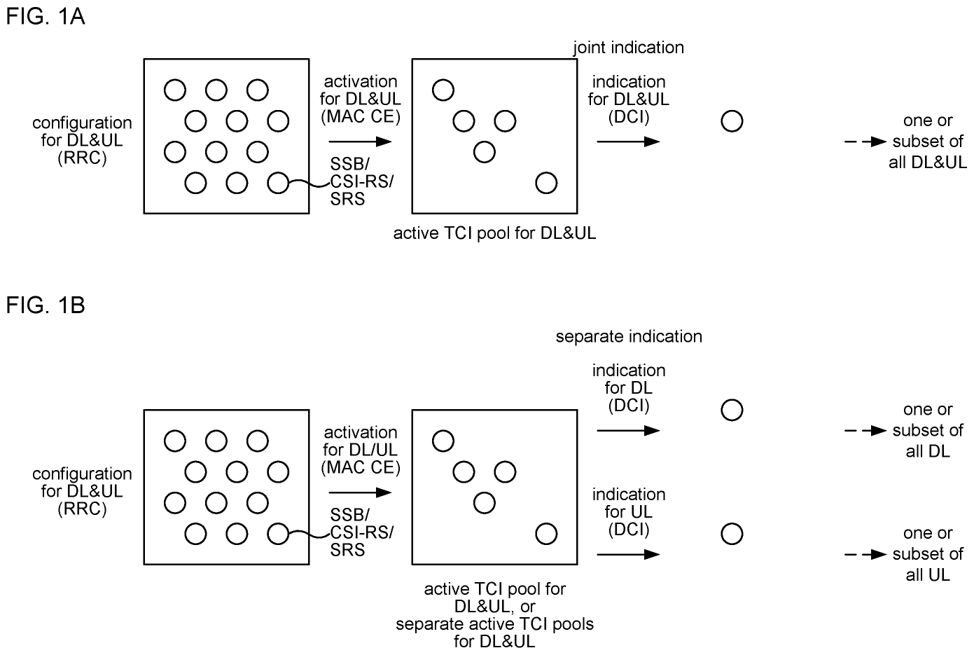

In an example of FIG. 1A, the RRC parameter (information element) configures a plurality of TCI states for both of the DL and UL. The MAC CE may activate a plurality of TCI states out of the plurality of configured TCI states. DCI may indicate one of the plurality of activated TCI states. The DCI may be UL/DL DCI. The indicated TCI state may be applied to at least one (or all) of UL/DL channels/RSs. One piece of DCI may indicate both a UL TCI and a DL TCI.

In the example of FIG. 1A, one dot may be one TCI state applied to both of the UL and DL, or may be two TCI states applied to respective ones of the UL and DL.

At least one of the plurality of TCI states configured by the RRC parameter and the plurality of TCI states activated by the MAC CE may be referred to as a TCI pool (common TCI pool, joint TCI pool, TCI state pool). The plurality of TCI states activated by the MAC CE may be referred to as an active TCI pool (active common TCI pool).

Note that in the present disclosure, a higher layer parameter (RRC parameter) for configuring a plurality of TCI states may be referred to as configuration information for configuring a plurality of TCI states, or may be simply referred to as “configuration information.” In the present disclosure, a case that one of a plurality of TCI states is indicated by using DCI may be reception of indication information for indicating one of a plurality of TCI states included in the DCI, or may simply be reception of “indication information.”

In an example of FIG. 1B, the RRC parameter configures a plurality of TCI states (joint common TCI pool) for both of the DL and UL. The MAC CE may activate a plurality of TCI states (active TCI pool) out of the plurality of configured TCI states. An (separate) active TCI pool for each of the UL and DL may be configured/activated.

DL DCI or a new DCI format may select (indicate) one or more (for example, one) TCI states. The selected TCI states may be applied to one or more (or all) DL channels/RSs. The DL channel may be a PDCCH/PDSCH/CSI-RS. The UE may determine a TCI state for each DL channel/RS by using TCI state operation (TCI framework) in Rel. 16. UL DCI or a new DCI format may select (indicate) one or more (for example, one) TCI states. The selected TCI states may be applied to one or more (or all) UL channels/RSs. The UL channel may be a PUSCH/SRS/PUCCH. Thus, different pieces of DCI may separately indicate the UL TCI and the DL DCI.

Existing DCI format 1_1/1_2 may be used for indication of the common TCI state.

A common TCI framework may have separate TCI states for the DL and UL.

### (Multiple TRPs)

One or a plurality of cells/transmission/reception points (TRPs) (multiple TRPs (Multi-TRP (MTRP))) that perform DL transmission to a UE are under study. Also, the UE that performs UL transmission to one or the plurality of cells/TRPs is under study. As procedure in this case, scenario 1 or scenario 2 below is conceivable. Note that in the present disclosure, a serving cell may be interpreted as a TRP in a serving cell. L1/L2 signaling and a MAC CE/DCI may be interchangeably interpreted. In the present disclosure, there is a case where a PCI different from a physical cell ID (Physical Cell Identity (PCI)) of a current serving cell is simply described as a “different PCI.” In scenario 1, for example, the following procedure is performed.

### <Scenario 1>

(1) The UE receives, from a serving cell, an SSB configuration for beam measurement in a TRP having a PCI different from that of the serving cell, and a configuration necessary for using a radio resource for data transmission/reception, the configuration including a resource for the different PCI.
(2) The UE performs beam measurement in the TRP having the different PCI, and reports a result of the beam measurement to the serving cell.
(3) On the basis of the above-described report, a TCI state associated with the TRP having the different PCI is activated by L1/L2 signaling from the serving cell.
(4) The UE performs transmission/reception by using a UE-dedicated channel on the TRP having the different PCI.
(5) It is necessary for the UE to always cover the serving cell, including a multi-TRP case. It is necessary for the UE to use a common channel (broadcast control channel (BCCH), paging channel (PCH)) or the like from the serving cell, in a manner similar to that in conventional systems.

In scenario 1, when the UE performs signal transmission/reception to/from a non-serving cell/TRP (TRP having a PCI of the non-serving cell), “serving cell” assumption is not changed. A higher layer parameter related to the PCI of the non-serving cell is configured for the UE from the serving cell. Scenario 1 may be employed in, for example, Rel. 17.

### <Scenario 2>

In scenario 2, L1/L2 inter-cell mobility is applied. In the L1/L2 inter-cell mobility, serving cell change can be performed without RRC reconfiguration by using a function, such as beam control. In other words, transmission/reception to/from a non-serving cell can be performed without handover. A data communication inhibition period, such as RRC reconnection necessary for the handover, occurs, and thus the L1/L2 inter-cell mobility not requiring the handover is applied, thereby allowing data communication to be continued in a case of the serving cell change. Scenario 2 may be employed in, for example, Rel. 18. In scenario 2, for example, the following procedure is performed.
(1) For beam measurement/serving cell change, the UE receives, from a serving cell, an SSB configuration for a cell (non-serving cell) having a different PCI.
(2) The UE performs beam measurement in the cell using the different PCI, and reports a result of the measurement to the serving cell.
(3) The UE may receive a configuration of the cell having the different PCI (serving cell configuration) by using higher layer signaling (for example, RRC). In other words, preconfiguration related to serving cell change may be performed. This configuration may be performed together with the configuration in (1), or may be performed separately from the configuration in (1).
(4) On the basis of the above-described report, a TCI state for the cell having the different PCI may be activated by L1/L2 signaling in accordance with the serving cell change. The activation of the TCI state and the serving cell change may be performed separately.
(5) The UE changes the serving cell, and initiates reception/transmission by using a preconfigured UE-dedicated channel and the TCI state.

In other words, in scenario 2, assumption of the serving cell is updated by the L1/L2 signaling.

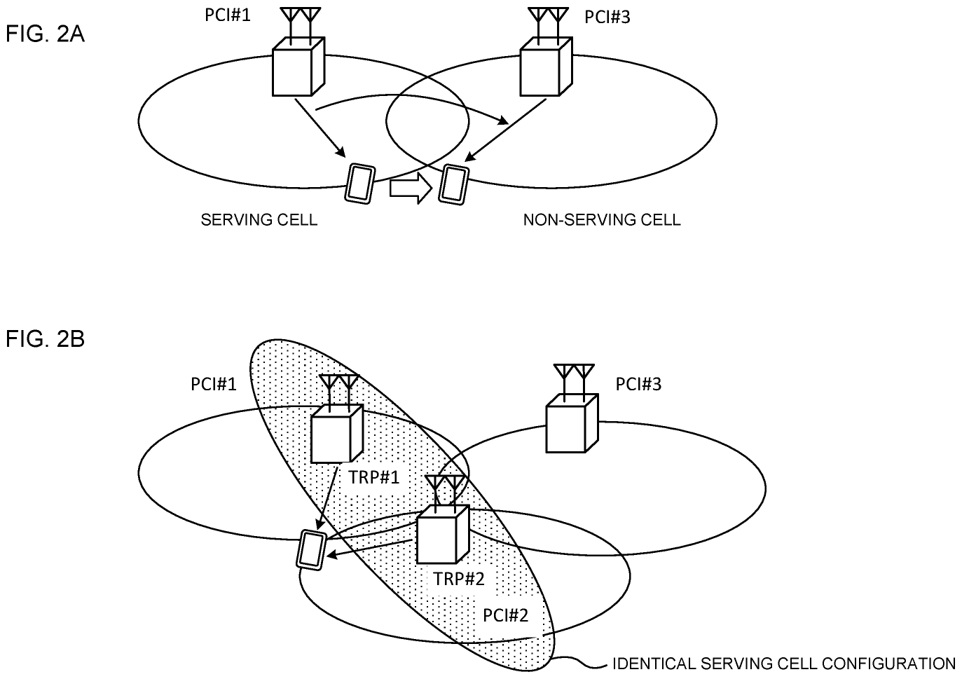

An example of a case where the UE receives channels/signals from a plurality of cells/TRPs in inter-cell mobility will be described by using FIGS. 2A and 2B.

FIG. 2A shows an example of the inter-cell mobility including the non-serving cell (for example, inter-cell mobility with a single TRP). The single TRP may mean a case where only one TRP out of multiple TRPs performs transmission to the UE (which may be referred to as a single mode). FIG. 2A shows a case where the UE receives channels/signals from a base station/TRP in cell #1 (PCI #1) being the serving cell and a base station/TRP in cell #3 (PCI #3) not being the serving cell (non-serving cell).

For example, the serving cell with the UE switches from cell #1 to cell #3 (for example, fast cell switch). In this case, TCI state update may be performed by DCI/MAC CE, and selection of a port (for example, an antenna port)/TRP/point may be performed dynamically.

FIG. 2B shows an example of a multi-TRP scenario (for example, inter-cell mobility in a case where multiple TRPs are used (Multi-TRP inter-cell mobility)). FIG. 2B shows a case where the UE receives channels/signals from TRP #1 and TRP #2. FIG. 2B shows a case where TRP #1 and TRP #2 are present in cell #1 (PCI #1) and cell #2 (PCI #2), respectively.

The multiple TRPs (TRP #1 and TRP #2) may be connected to each other by an ideal/non-ideal backhaul, and information, data, and the like may be exchanged. From respective TRPs of the multiple TRPs, different codewords (CWs) and different layers may be transmitted. As a mode of multi-TRP transmission, non-coherent joint transmission (NCJT) may be used. In FIG. 2B, the NCJT may be performed between a plurality of cells (cells with different PCIs). Note that the same serving cell configuration may be applied to/configured for TRP #1 and TRP #2.

In the NCJT, for example, TRP #1 performs modulation mapping and layer mapping for a first codeword to transmit a first number of layers (for example, 2 layers) and to transmit a first signal/channel (for example, a PDSCH) by using first precoding. Also, TRP #2 performs modulation mapping and layer mapping for a second codeword to transmit a second number of layers (for example, 2 layers) and to transmit a second signal/channel (for example, a PDSCH) by using second precoding.

A plurality of PDSCHs (multiple PDSCHs) transmitted by NCJT may be defined as PDSCHs partially or fully overlapping with each other in relation to at least one of time and frequency domains. In other words, a first PDSCH from TRP #1 and a second PDSCH from TRP #2 may overlap with each other in at least one of time and frequency resources.

It may be assumed that these first and second PDSCHs are not in a quasi-co-location (QCL) relationship (not quasi-co-located). Reception of the multiple PDSCHs may be interpreted as simultaneous reception of PDSCHs of a QCL type other than a certain QCL type (for example, QCL type D).

A plurality of PDSCHs (which may be referred to as multiple PDSCHs) from the multiple TRPs may be scheduled by using one piece of DCI (single DCI (S-DCI), single PDCCH) (single master mode). The one piece of DCI may be transmitted from one TRP of the multiple TRPs. A structure using one piece of DCI in the multiple TRPs may be referred to as single-DCI based multi-TRP (mTRP/MTRP).

A case where respective multiple TRPs transmit part of a control signal to the UE and where the multiple TRPs transmit a data signal (which may be referred to as a master slave mode) may be employed.

A respective plurality of PDSCHs from the multiple TRPs may be scheduled by using a plurality of pieces of DCI (multiple DCI (M-DCI), multiple PDCCHs) (multi-master mode). The plurality of pieces of DCI may be transmitted from the respective multiple TRPs. A structure using a plurality of pieces of DCI in the multiple TRPs may be referred to as multi-DCI based multi-TRP (mTRP/MTRP).

The UE may assume that for different TRPs, separate CSI reports related to the respective TRPs are transmitted. Such CSI feedback may be referred to as separate feedback, separate CSI feedback, and the like. In the present disclosure, “separate” may be interpreted as “independent” and vice versa.

### (Issues)

In a case where inter-cell mobility including another cell (non-serving cell) having a physical cell ID different from a physical cell ID of a serving cell is applied, processing in a case where transmission/reception to/from such another cell is performed remains indefinite. Therefore, appropriate transmission/reception to/from such another cell fails, and throughput reduction or communication quality degradation may occur. For example, the following issues are conceivable.

### <Issue 1>

For L1/L2 inter-cell mobility, beam indication based on a unified (common) TCI framework is under study. However, when a common TCI state associated with a cell with a different PCI is indicated by a MAC CE and/or DCI, which channel the common TCI state (beam) is applicable to is indefinite. For example, whether the common TCI state is applicable to a PDSCH/PUSCH associated with a UE-dedicated CORESET, a UE-dedicated PDCCH/PUCCH, some group-common PDCCHs, a semi-persistent scheduling (SPS) PDSCH/cell-group (CG) PUSCH, and the like remains indefinite.

### <Issue 2>

For example, it is conceivable that serving cell change is absent (scenario 1) in Rel. 17 and that serving cell change is supported by L1/L2 inter-cell mobility in Rel. 18. However, detailed design for supporting serving cell change (signaling design or the like) remains indefinite.

### <Issue 3>

UE operation after reception of serving cell change indication with the L1/L2 inter-cell mobility remains indefinite.

Thus, the inventors of the present invention came up with the idea of a terminal that can appropriately perform transmission/reception to/from another cell.

Embodiments according to the present disclosure will be described in detail with reference to the drawings as follows. The radio communication methods according to respective embodiments may each be employed individually, or may be employed in combination.

In the present disclosure, “A/B/C” and “at least one of A, B, and C” may be interchangeably interpreted. In the present disclosure, a cell, a serving cell, a CC, a carrier, a BWP, a DL BWP, a UL BWP, an active DL BWP, an active UL BWP, and a band may be interchangeably interpreted. In the present disclosure, an index, an ID, an indicator, and a resource ID may be interchangeably interpreted. In the present disclosure, “support,” “control,” “controllable,” “operate,” and “operable” may be interchangeably interpreted.

In the present disclosure, configuration (configure), activation (activate), update, indication (indicate), enabling (enable), specification (specify), and selection (select) may be interchangeably interpreted.

In the present disclosure, the higher layer signaling may be, for example, any one or combinations of Radio Resource Control (RRC) signaling, Medium Access Control (MAC) signaling, broadcast information, and the like. In the present disclosure, RRC, RRC signaling, an RRC parameter, a higher layer, a higher layer parameter, an RRC information element (IE), and an RRC message may be interchangeably interpreted.

The MAC signaling may use, for example, a MAC control element (MAC CE), a MAC Protocol Data Unit (PDU), or the like. The broadcast information may be, for example, a master information block (MIB), a system information block (SIB), minimum system information (Remaining Minimum System Information (RMSI)), other system information (OSI), or the like.

The physical layer signaling may be, for example, downlink control information (DCI).

In the present disclosure, a MAC CE and an activation/deactivation command may be interchangeably interpreted.

In the present disclosure, a pool, a set, a group, a list, and candidates may be interchangeably interpreted.

In the present disclosure, a DMRS, a DMRS port, and an antenna port may be interchangeably interpreted.

In the present disclosure, a beam, a spatial domain filter, a spatial setting, a TCI state, a UL TCI state, a unified TCI state, a unified beam, a common TCI state, a common beam, TCI assumption, QCL assumption, a QCL parameter, a spatial domain reception filter, a UE spatial domain reception filter, a UE receive beam, a DL beam, a DL receive beam, DL precoding, a DL precoder, a DL-RS, a QCL type D RS in a TCI state/QCL assumption, a QCL type A RS in a TCI state/QCL assumption, a spatial relation, a spatial domain transmission filter, a UE spatial domain transmission filter, a UE transmit beam, a UL beam, a UL transmit beam, UL precoding, a UL precoder, and a PL-RS may be interchangeably interpreted. In the present disclosure, a QCL type X-RS, a DL-RS associated with QCL type X, a DL-RS having QCL type X, a DL-RS source, an SSB, a CSI-RS, and an SRS may be interchangeably interpreted.

In the present disclosure, a common beam, a common TCI, a common TCI state, a unified TCI, a unified TCI state, a TCI state applicable to DL and UL, a TCI state applied to a plurality (multiple types) of channels/RSs, a TCI state applicable to multiple types of channels/RSs, and a PL-RS may be interchangeably interpreted. “Common,” “unified,” and “joint” may be interchangeably interpreted.

In the present disclosure, a TCI state, a plurality of TCI states configured by RRC, a plurality of TCI states activated by a MAC CE, a pool, a TCI state pool, an active TCI state pool, a common TCI state pool, a joint TCI state pool, a separate TCI state pool, a UL common TCI state pool, a DL common TCI state pool, a common TCI state pool configured/activated by RRC/MAC CE, and TCI state information may be interchangeably interpreted.

In the present disclosure, a panel, an Uplink (UL) transmission entity, a TRP, a spatial relation, a control resource set (CORESET), a PDSCH, a codeword, a base station, an antenna port for a certain signal (for example, a demodulation reference signal (DMRS) port), an antenna port group for a certain signal (for example, a DMRS port group), a group for multiplexing (for example, a code division multiplexing (CDM) group, a reference signal group, or a CORESET group), a CORESET pool, a CORESET subset, a CW, a redundancy version (RV), and a layer (MIMO layer, transmission layer, spatial layer) may be interchangeably interpreted. A panel Identifier (ID) and a panel may be interchangeably interpreted. In the present disclosure, a TRP ID, a TRP-related ID, a CORESET pool index, a location of one TCI state out of two TCI states corresponding to one codepoint of a field in DCI (ordinal number, first TCI state or second TCI state), and a TRP may be interchangeably interpreted.

In the present disclosure, a TRP, a transmission point, a panel, a DMRS port group, a CORESET pool, and one of two TCI states associated with one codepoint of a TCI field may be interchangeably interpreted.

In the present disclosure, a single TRP, single DCI, a single PDCCH, multi-TRP based on single DCI, a single-TRP system, single-TRP transmission, a single PDSCH, a channel using a single TRP, a channel using one TCI state/spatial relation, multi-TRP being not enabled by RRC/DCI, a plurality of TCI states/spatial relations being not enabled by RRC/DCI, a CORESET pool index (CORESETPoolIndex) value with “1” being not configured for any CORESET and any codepoint of a TCI field being not mapped to two TCI states, and activation of two TCI states on at least one TCI codepoint may be interchangeably interpreted.

In the present disclosure, multi-TRP, a multi-TRP system, multi-TRP transmission, multiple PDSCHs, a channel using multi-TRP, a channel using a plurality of TCI states/spatial relations, multi-TRP being enabled by RRC/DCI, a plurality of TCI states/spatial relations being enabled by RRC/DCI, and at least one of multi-TRP based on single DCI and multi-TRP based on multi-DCI may be interchangeably interpreted. In the present disclosure, multi-TRP based on multi-DCI and one CORESET pool index (CORESETPoolIndex) value being configured for a CORESET may be interchangeably interpreted. In the present disclosure, multi-TRP based on single DCI and at least one codepoint in a TCI field being mapped to two TCI states may be interchangeably interpreted.

In the present disclosure, TRP #1 (first TRP) may correspond to CORESET pool index=0, or may correspond to a first TCI state out of two TCI states corresponding to one codepoint of a TCI field. TRP #2 (second TRP) may correspond to CORESET pool index=1, or may correspond to a second TCI state out of the two TCI states corresponding to one codepoint of the TCI field.

In the present disclosure, a cell, a serving cell, a CC, a BWP, a BWP in a CC, and a band may be interchangeably interpreted.

In the present disclosure, another cell, a non-serving cell, a cell having a different PCI, a candidate serving cell, a cell having a PCI different from a PCI of a current serving cell, and a different serving cell may be interchangeably rephrased. “Dedicated” and “specific” may be interchangeably interpreted.

### (Radio Communication Method)

### First Embodiment

Information for indicating a common TCI state associated with another cell having a physical cell ID (PCI) different from a PCI of a serving cell is received. The common TCI state may be a TCI state applicable to multiple types of channels/signals. The common TCI state may be at least one of a first TCI state common to both downlink (DL) and uplink (UL), a second TCI state common to the DL, and a third TCI state common to the UL. The first TCI state may be a TCI state (joint TCI state) applicable to multiple types of channels/signals for the DL and UL. The second TCI state may be a TCI state (separate DL TCI state) applicable to multiple types of channels/signals for the DL. The second TCI state may be a TCI state (separate UL TCI state) applicable to multiple types of channels/signals for the UL. The information for indicating the first TCI state is, for example, indication by a MAC CE and DCI shown in FIG. 1A. The information for indicating the second TCI state and the third TCI state is, for example, indication by a MAC CE and DCI shown in FIG. 1B. The UE applies, to a specific channel transmitted/received for such another cell, at least one of the first TCI state, second TCI state, and third TCI state indicated in the information. This specific channel is at least one of CH 1 to CH 9 below.
CH 1: CH 1 may include CH 1_DL/CH 1_UL below.
   CH 1_DL: PDSCH scheduled by UE-dedicated CORESET/UE-specific search space (USS) (PDSCH scheduled by a PDCCH detected in the CORESET/USS)
   CH 1_UL: PUSCH scheduled by UE-dedicated CORESET/USS (PUSCH scheduled by a PDCCH detected in the CORESET/USS)
CH 2: CH 2 may include CH 2_DL/CH 2_UL below.
   CH 2_DL: UE-dedicated PDCCH
   CH 2_UL: UE-dedicated PUCCH
CH 3: CH 3 may include CH 3_UL below.
   CH 3_UL: Type 1 CG PUSCH configured by higher layer signaling (for example, RRC)
CH 4: CH 4 may include CH 4_DL/CH 4_UL below.
   CH 4_DL: SPS PDSCH configured by higher layer signaling (for example, RRC) and activated by DCI
   CH 4_UL: Type 2 CG PUSCH configured by higher layer signaling (for example, RRC) and activated by DCI
CH 5: PDCCH detected in Type 0-PDCCH shared search space (Common Search Space (CSS))
CH 6: PDCCH detected in Type 0A-PDCCH CSS
CH 7: PDCCH detected in Type 1-PDCCH CSS
CH 8: PDCCH detected in Type 2-PDCCH CSS
CH 9: PDCCH detected in Type 3-PDCCH CSS

### [Aspect 1-1]

When a joint DL/UL TCI state associated with a cell having a PCI different from the PCI of the serving cell (first TCI state common to both of the DL and UL) is indicated by the MAC CE/DCI (for example, see FIG. 1A), any one of option 1-1 to option 1-4 below may be employed in a channel to which the TCI state is applicable. Note that the TCI state may be, for example, a common TCI state defined in Rel. 17. In the present disclosure, “A/B/C” and “at least one of A, B, and C” may be interchangeably interpreted. “/” may be interpreted as “and” or “or.”

### [Option 1-1] Only CH 1

### [Option 1-2] CH 1/CH 2

### [Option 1-3] CH 1/CH 2/CH 3/CH 4

### [Option 1-4] CH 1/CH 2/CH 9

The above-described channel to which the common TCI state (beam) is applicable is not limited to the above-described respective options (option 1-1/option 1-2/option 1-3/option 1-4), and, for example, a combination of two or more options or a combination of a channel of each option and another channel may be employed in the above-described channel. Note, however, that CH 5/CH 6/CORESET #0 may not be allowed. CH 7/CH 8 may be allowed, or may not be allowed.

### [Aspect 1-2]

When a separate DL/UL TCI state associated with the cell having the PCI different from the PCI of the serving cell (at least one of the second TCI state common to the DL and the third TCI state common to the UL) is indicated by the MAC CE/DCI (for example, see FIG. 1B), any one of option 1-5 to option 1-8 below may be employed in a channel to which the DL common TCI state (second TCI state) is applicable. Any one of option 1-9 to option 1-11 below may be employed in a channel to which the UL common TCI state (third TCI state) is applicable.

### [Option 1-5] Only CH 1_DL

### [Option 1-6] CH 1_DL/CH 2_DL

### [Option 1-7] CH 1_DL/CH 2_DL/CH 4_DL

### [Option 1-8] CH 1_DL/CH 2_DL/CH 9

The above-described channel to which the DL common TCI state is applicable is not limited to the above-described respective options (option 1-5/option 1-6/option 1-7/option 1-8), and, for example, a combination of two or more options or a combination of each option and another DL channel may be employed in the above-described channel. CH 5/CH 6/CORESET #0 may not be allowed. CH 7/CH 8 may be allowed, or may not be allowed.

### [Option 1-9] Only CH 1_UL

### [Option 1-10] CH 1_UL/CH 2_UL

### [Option 1-11] CH 1_UL/CH 2_UL/CH 3_UL/CH 4_UL

The above-described channel to which the UL common TCI state is applicable is not limited to the above-described respective options (option 1-9/option 1-10/option 1-11), and, for example, a combination of two or more options or a combination of each option and another UL channel may be employed in the above-described channel.

According to the present embodiment, which channel the common TCI state associated with the cell with the different PCI is applied to becomes definite. In other words, issue 1 described above can be resolved.

For example, when the UE can receive a PDSCH from the cell having the different PCI, it is necessary to monitor at least an SIB/paging and a random access response (RAR) from the serving cell. In other words, UE processing load increases. However, channels transmitted/received to/from the cell having the different PCI are limited, thereby the UE processing load can be reduced.

### Second Embodiment

In a second embodiment, implicit or explicit signaling for serving cell change indication will be described. As a TCI state in the present embodiment, at least one of the first TCI state, second TCI state, and third TCI state in the first embodiment (joint TCI state or separate TCI state) may be employed.

### [Aspect 2-1]

In aspect 2-1, implicit signaling for serving cell change indication will be described. In aspect 2-1, for example, scenario 2 mentioned above is employed.

### [[Option 2-1] ]

When a specific control resource set (CORESET) (for example, at least one of CORESET #0, a CORESET with CH 5 Type 0-CSS, and a CORESET with CH 6/CH 7/CH 8 CSS), together with one or more TCI states associated with a cell with a PCI different from a PCI of a serving cell, is indicated (activated) by a MAC CE (when one or more TCI states associated with the cell with the PCI different from the PCI of the serving cell are indicated/activated for the specific CORESET by the MAC CE), the UE may judge that the serving cell is changed to another cell (cell x, cell having a different PCI). In other words, this activation may implicitly indicate that the serving cell is changed to another cell.

In this case, the UE may update, to the same TCI state as the above-described activated TCI state, a beam for another CORESET ID, another CORESET to use CH 6/CH 7/CH 8, or another CORESET to use a CSS.

### [[Option 2-2] ]

When the MAC CE activates/deactivates PDSCH TCI states, and all of the TCI states activated by the MAC CE are associated with same cell x having a PCI different from the PCI of the serving cell, the UE may judge that the serving cell is changed to another cell (cell x). In other words, this association may implicitly indicate that the serving cell is changed to another cell.

In a case in which this option is employed, when a NW (base station) does not change the serving cell, it is necessary that when the MAC CE activates PDSCH TCI states associated with the cell having the different PCI, a TCI state related to a different cell (for example, a current serving cell or a cell having a second different PCI) is also included in the activation.

### [[Option 2-3] ]

When the MAC CE activates/deactivates unified TCI states (corresponding to, for example, a unified TCI framework in Rel. 17), and all of the activated unified TCI states are associated with same cell x having the different PCI, the UE may judge that the serving cell is changed to another cell (cell x). In other words, this association may implicitly indicate that the serving cell is changed to another cell.

### [[Variation] ]

In option 2-2/option 2-3, in a case where some TCI states out of the active TCI states are associated with Cell #1/PCI #1, and another TCI state is associated with Cell #2/PCI #2 (the case is referred to as a case of variation), at least one of (1) to (3) below may be employed. For example, different TCI codepoints may indicate different cells/PCIs.
(1) The UE does not update (change) serving cell assumption. Note, however, that the UE can perform signal transmission/reception to/from a non-serving cell/PCI (in other words, the UE supports scenario 1).
(2) The UE can connect to a plurality of serving cells (the UE can assume a plurality of serving cells). The UE can perform signal transmission/reception to/from a plurality of serving cells/PCIs.
(3) When scenario 2 is applied, the UE does not assume (expect) that different TCI codepoints are configured to indicate different cells/PCIs.

Note that this case of the variation may occur when different PCI cells share the same (or almost the same) serving cell configuration under a current single cell configuration framework. Thus, the UE can dynamically switch two cells for PDSCH reception in a manner similar to that of an mTRP configuration framework. In a case other than the case, the UE needs to maintain a plurality of serving cell configurations simultaneously. For example, when the UE receives a PDSCH from PCI #1, the UE uses a PDSCH configuration for PCI #1. When the UE receives a PDSCH from PCI #2, the UE uses a PDSCH configuration for PCI #2. The UE may maintain two user planes (U-planes) in response to the configurations.

Therefore, when cells having a different PCI share a serving cell configuration (or at least the same PDSCH configuration), there is a possibility that the above-described case of the variation occurs (the UE assumes the above-described case of the variation). Note, however, that when serving cell configurations (or at least dedicated PDSCH configurations) for different PCI cells are different from each other, the UE may not assume the above-described case of the variation.

### [Aspect 2-2]

In aspect 2-2, explicit signaling for serving cell change indication will be described. In aspect 2-2, for example, scenario 2 mentioned above is employed.

### [[Option 2-3] ]

An example of the serving cell change indication will be described below. Note that activation/deactivation of a non-serving cell, change of a serving cell, and transmission/reception to/from another cell (non-serving cell) having a physical cell ID different from a physical cell ID of the serving cell may be interchangeably interpreted.

The UE may receive a new MAC CE used for activation/deactivation of a non-serving cell, the MAC CE including at least one of fields (information) indicating (1) to (3) below corresponding to the non-serving cell. The UE may, when receiving the MAC CE, judge that the serving cell is changed to another cell (non-serving cell). The UE may control, on the basis of the information, DL signal/UL signal transmission/reception to/from the non-serving cell. Note that the non-serving cell may correspond to one non-serving cell or a plurality of non-serving cells. In the example described below, a MAC CE including a plurality of fields indicating a plurality of non-serving cell indices is employed.
(1) Serving cell ID
(2) BWP ID
(3) Non-serving cell ID used for activation The non-serving cell

ID may be replaced with arbitrary information (with which the non-serving cell can be identified) corresponding to the non-serving cell.

For example, any one of (3-1) to (3-5) may be employed as an example of (3).
(3-1) PCI (PCI to be directly used) For example, 10 bits are used.
(3-2) Recreated index of non-serving cell (new ID) The new ID may be associated with part of the PCI, and may be configured for only a serving cell and a non-serving cell used by (available to) the UE. The new ID can reduce the number of bits more than the PCI does.
(3-3) CSI report configuration ID (CSI-ReportConfigId) (when CSI-ReportConfig corresponds to one or a plurality of non-serving cells)
(3-4) CSI resource configuration ID (CSI-ResourceConfigId) (when CSI-ResourceConfigId corresponds to one or a plurality of non-serving cells)
(3-5) Bitmap indicating activation/deactivation of each non-serving cell A size (the number of bits) of the bitmap may be the same as the number of non-serving cells configured on this CC. For example, when a second non-serving cell out of three non-serving cells is activated, “010” is configured.

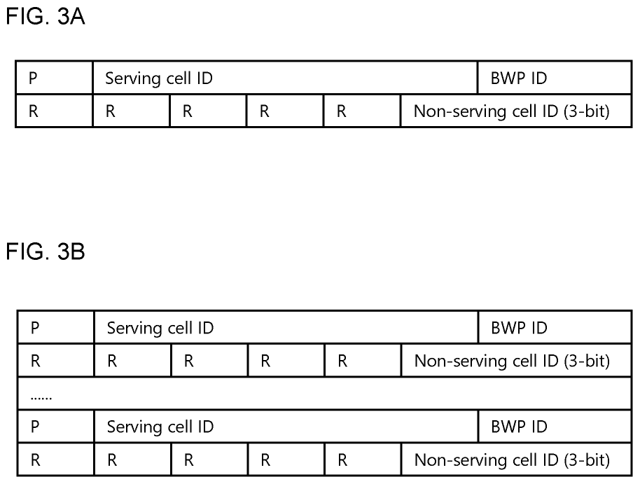

FIGS. 3A and 3B are each a diagram to show a first example of the MAC CE. In FIGS. 3A and 3B, it is assumed that seven non-serving cells are present. FIGS. 3A and 3B each includes the fields with (1) to (3) described above. A non-serving cell ID (3-bits) may indicate one non-serving cell activated for L1 beam reporting. The number of bits of the non-serving cell ID may not be 3 bits, and may vary depending on the number (maximum number) of non-serving cells.

A “P” field may indicate whether a subsequent octet (entry) is present. The “P” field may indicate whether at least one of (1) to (3) is present in the MAC CE. FIG. 3A corresponds to one CC. FIG. 3B corresponds to a plurality of CCs, and the fields with (1) to (3) and the “P” field are included for each CC.

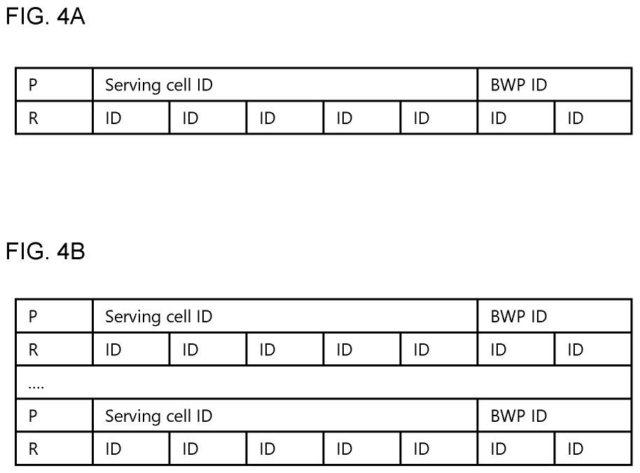

FIGS. 4A and 4B are each a diagram to show a second example of the MAC CE. FIGS. 4A and 4B differ from FIGS. 3A and 3B in that the non-serving cell ID (3-bits) is replaced with seven IDs (7-bit bitmap), and are similar to FIGS. 3A and 3B in other respects. The seven IDs correspond to (3-5) described above, and each of the seven IDs corresponds to a non-serving cell. The seven IDs may be represented as, for example, T₁, T₂ . . . , T₇. FIG. 4A corresponds to one CC. FIG. 4B corresponds to a plurality of CCs, and the fields with (1) to (3) and the “P” field are included for each CC.

At least one of the above-mentioned information included in the MAC CE may be included in DCI. Alternatively, at least one of serving cells activated by the MAC CE may be indicated by the DCI. The MAC CE/DCI may include a field for indicating a TCI state/SSB/CSI-RS from the cells having a different PCI so that the UE can recognize, on a target cell (changed serving cell), a DL beam to be monitored. The UE may create, by using the TCI state/SSB/CSI-RS, a beam report (CSI report) to transmit.

For example, when a separate DL/UL TCI state (see FIG. 1B) is applied, the MAC CE/DCI may include an additional field indicating a UL beam/TCI state/spatial relation/SSB/CSI-RS/SRS for the target cell.

### [[Option 2-4] ]

The UE may receive a MAC CE obtained by adding a new 1-bit field “C” to an existing MAC CE. The field indicates whether to change a serving cell. The UE may receive the MAC CE to judge, on the basis of the field, whether the serving cell is changed to such another cell.

For example, at least one of a field for indicating activation/deactivation of a PDSCH TCI state, a field for indicating activation/deactivation of cells having a different PCI, a field indicating an RS (for example, an SSB) for beam measurement/reporting in cells having a different PCI, and a field indicating another purpose/function may be added to the existing MAC CE. In this case, the number of cells associated with/indicated by the different PCI in MAC CE may be only 1 cell.

Each field described in this option may be employed in combination with the existing MAC CE or any one of the MAC CES shown in FIGS. 3A, 3B, 4A, and 4B.

### [[Option 2-5]]

For the MAC CE in option 2-4, the MAC CEs shown in FIGS. 3A, 3B, 4A, and 4B may each further include a field indicating a serving cell index/PCI/another ID (the above-mentioned new ID in option 2-3 or the like), or a field for a TCI state/SSB/CSI-RS for a target cell (changed serving cell).

For example, when the separate DL/UL TCI state is applied (see FIG. 1B), the MAC CEs shown in FIGS. 3A, 3B, 4A, and 4B may each include an additional field for a UL beam/TCI state/spatial relation/SSB/CSI-RS/SRS for the target cell.

According to the present embodiment, detailed design for supporting serving cell change becomes definite, and thus it is possible to appropriately perform serving cell change. In other words, issue 2 described above can be resolved.

### Third Embodiment

In the present embodiment, UE operation after detection of implicit/explicit serving cell change indication (for example, see the second embodiment) will be described. As a TCI state in the present embodiment, at least one of the first TCI state, second TCI state, and third TCI state in the first embodiment (joint TCI state or separate TCI state) may be employed.

A UE changes a serving cell configuration to a target cell (another cell, changed serving cell) configuration on the basis of a configuration of a plurality of cells received beforehand by using higher layer signaling (for example, RRC). The configuration may be, for example, a CSI report configuration (CSI-ReportConfig), a CSI resource configuration (CSI-ResourceConfig), or the like.

The UE flushes/clears a configured DL/UL resource of the serving cell before the change to recreate a configured DL/UL resource of the target cell. The UE may store a configuration of the previous serving cell for a case where handover back occurs (the serving cell is changed to the previous serving cell).

The UE receives a DL transmission from the target cell by using a new beam/TCI state in accordance with MAC CE-based indication (for example, a TCI state (beam)/SSB/CSI-RS) related to the target cell, described in the second embodiment. When the indication related to the target cell is absent, the new beam/TCI state may correspond to the latest PRACH transmission related to the SSB of the target cell.

The UE may receive, as DL to be received from the target cell, at least one of only CORESET #0, CH 5, CH 6, CH 7, CH 8, CH 9, CH 1_DL, CH 2_DL, and CH 4_DL.

When the indication (TCI state (beam)/SSB/CSI-RS) related to the target cell, described in the second embodiment, is present, the UE transmits, in accordance with the indication, a UL signal to the target cell by using assumption of a new beam/TCI state/spatial relation. When indication of a TCI state (beam) or a UL TCI state (beam) for the target cell is absent in the second embodiment, the new beam/TCI state/spatial relation may correspond to the latest PRACH transmission related to the SSB of the target cell.

The UE may transmit, as UL to be transmitted to the target cell, at least one of CH 1_UL, CH 2_UL, CH 3_UL, and CH 4_UL. Note that the UE may change only a DL beam for the target cell without changing a UL beam for the target cell. The UL beam may be configured from RRC configuration signaling.

According to the present embodiment, UE operation after reception of serving cell change indication with L1/L2 inter-cell mobility becomes definite. In other words, issue 3 described above is resolved.

### <UE Capability>

The UE may report (transmit) UE capability information indicating whether to support at least one of respective processes in the present disclosure. For example, the UE may transmit UE capability information about at least one of (1) to (3) below.
(1) Whether to support serving cell change indication using MAC CE/DCI
(2) Whether to support automatic DL beam (TCI state) update by the UE after L1/L2 serving cell change (using MAC CE/DCI)
(3) Whether to support automatic UL beam (TCI state) update by the UE after L1/L2 serving cell change (using MAC CE/DCI)

The UE may receive, by using DCI/MAC CE/higher layer signaling or the like, information for indicating/configuring at least one of the respective processes in the present disclosure. The information may correspond to the UE capability information transmitted by the UE.

### (Radio Communication System)

Hereinafter, a structure of a radio communication system according to one embodiment of the present disclosure will be described. In this radio communication system, the radio communication method according to each embodiment of the present disclosure described above may be used alone or may be used in combination for communication.

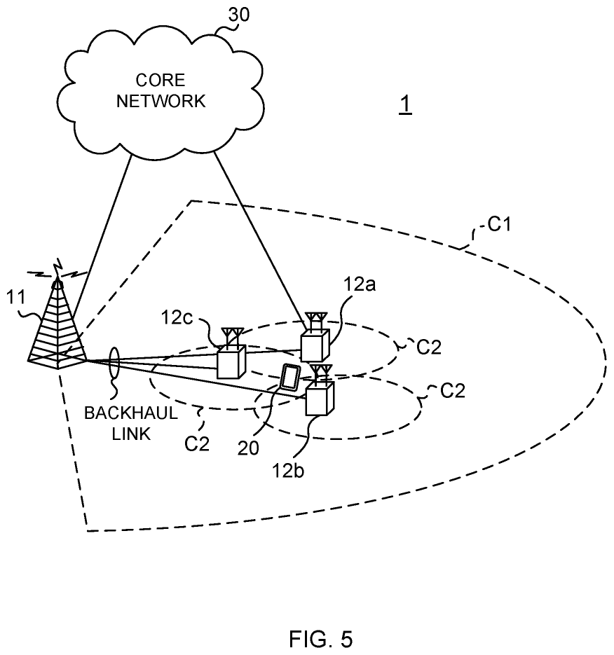

FIG. 5 is a diagram to show an example of a schematic structure of the radio communication system according to one embodiment. The radio communication system 1 may be a system implementing a communication using Long Term Evolution (LTE), 5th generation mobile communication system New Radio (5G NR) and so on the specifications of which have been drafted by Third Generation Partnership Project (3GPP).

The radio communication system 1 may support dual connectivity (multi-RAT dual connectivity (MR-DC)) between a plurality of Radio Access Technologies (RATs). The MR-DC may include dual connectivity (E-UTRA-NR Dual Connectivity (EN-DC)) between LTE (Evolved Universal Terrestrial Radio Access (E-UTRA)) and NR, dual connectivity (NR-E-UTRA Dual Connectivity (NE-DC)) between NR and LTE, and so on.

In EN-DC, a base station (eNB) of LTE (E-UTRA) is a master node (MN), and a base station (gNB) of NR is a secondary node (SN). In NE-DC, a base station (gNB) of NR is an MN, and a base station (eNB) of LTE (E-UTRA) is an SN.

The radio communication system 1 may support dual connectivity between a plurality of base stations in the same RAT (for example, dual connectivity (NR-NR Dual Connectivity (NN-DC)) where both of an MN and an SN are base stations (gNB) of NR).

The radio communication system 1 may include a base station 11 that forms a macro cell C1 of a relatively wide coverage, and base stations 12 (12a to 12c) that form small cells C2, which are placed within the macro cell C1 and which are narrower than the macro cell C1. The user terminal 20 may be located in at least one cell. The arrangement, the number, and the like of each cell and user terminal 20 are by no means limited to the aspect shown in the diagram. Hereinafter, the base stations 11 and 12 will be collectively referred to as “base stations 10,” unless specified otherwise.

The user terminal 20 may be connected to at least one of the plurality of base stations 10. The user terminal 20 may use at least one of carrier aggregation (CA) and dual connectivity (DC) using a plurality of component carriers (CCs).

Each CC may be included in at least one of a first frequency band (Frequency Range 1 (FR1)) and a second frequency band (Frequency Range 2 (FR2)). The macro cell C1 may be included in FR1, and the small cells C2 may be included in FR2. For example, FR1 may be a frequency band of 6 GHz or less (sub-6 GHZ), and FR2 may be a frequency band which is higher than 24 GHZ (above-24 GHz). Note that frequency bands, definitions and so on of FR1 and FR2 are by no means limited to these, and for example, FR1 may correspond to a frequency band which is higher than FR2.

The user terminal 20 may communicate using at least one of time division duplex (TDD) and frequency division duplex (FDD) in each CC.

The plurality of base stations 10 may be connected by a wired connection (for example, optical fiber in compliance with the Common Public Radio Interface (CPRI), the X2 interface and so on) or a wireless connection (for example, an NR communication). For example, if an NR communication is used as a backhaul between the base stations 11 and 12, the base station 11 corresponding to a higher station may be referred to as an “Integrated Access Backhaul (IAB) donor,” and the base station 12 corresponding to a relay station (relay) may be referred to as an “IAB node.”

The base station 10 may be connected to a core network 30 through another base station 10 or directly. For example, the core network 30 may include at least one of Evolved Packet Core (EPC), 5G Core Network (5GCN), Next Generation Core (NGC), and so on.

The user terminal 20 may be a terminal supporting at least one of communication schemes such as LTE, LTE-A, 5G, and so on.

In the radio communication system 1, an orthogonal frequency division multiplexing (OFDM)-based wireless access scheme may be used. For example, in at least one of the downlink (DL) and the uplink (UL), Cyclic Prefix OFDM (CP-OFDM), Discrete Fourier Transform Spread OFDM (DFT-s-OFDM), Orthogonal Frequency Division Multiple Access (OFDMA), Single Carrier Frequency Division Multiple Access (SC-FDMA), and so on may be used.

The wireless access scheme may be referred to as a “waveform.” Note that, in the radio communication system 1, another wireless access scheme (for example, another single carrier transmission scheme, another multi-carrier transmission scheme) may be used for a wireless access scheme in the UL and the DL.

In the radio communication system 1, a downlink shared channel (Physical Downlink Shared Channel (PDSCH)), which is used by each user terminal 20 on a shared basis, a broadcast channel (Physical Broadcast Channel (PBCH)), a downlink control channel (Physical Downlink Control Channel (PDCCH)) and so on, may be used as downlink channels.

In the radio communication system 1, an uplink shared channel (Physical Uplink Shared Channel (PUSCH)), which is used by each user terminal 20 on a shared basis, an uplink control channel (Physical Uplink Control Channel (PUCCH)), a random access channel (Physical Random Access Channel (PRACH)) and so on may be used as uplink channels.

User data, higher layer control information, System Information Blocks (SIBs) and so on are communicated on the PDSCH. User data, higher layer control information and so on may be communicated on the PUSCH. The Master Information Blocks (MIBs) may be communicated on the PBCH.

Lower layer control information may be communicated on the PDCCH. For example, the lower layer control information may include downlink control information (DCI) including scheduling information of at least one of the PDSCH and the PUSCH.

Note that DCI for scheduling the PDSCH may be referred to as “DL assignment,” “DL DCI,” and so on, and DCI for scheduling the PUSCH may be referred to as “UL grant,” “UL DCI,” and so on. Note that the PDSCH may be interpreted as “DL data”, and the PUSCH may be interpreted as “UL data”.

For detection of the PDCCH, a control resource set (CORESET) and a search space may be used. The CORESET corresponds to a resource to search DCI. The search space corresponds to a search area and a search method of PDCCH candidates. One CORESET may be associated with one or more search spaces. The UE may monitor a CORESET associated with a certain search space, based on search space configuration.

One search space may correspond to a PDCCH candidate corresponding to one or more aggregation levels. One or more search spaces may be referred to as a “search space set.” Note that a “search space,” a “search space set,” a “search space configuration,” a “search space set configuration,” a “CORESET,” a “CORESET configuration” and so on of the present disclosure may be interchangeably interpreted.

Uplink control information (UCI) including at least one of channel state information (CSI), transmission confirmation information (for example, which may be also referred to as Hybrid Automatic Repeat reQuest ACKnowledgement (HARQ-ACK), ACK/NACK, and so on), and scheduling request (SR) may be communicated by means of the PUCCH. By means of the PRACH, random access preambles for establishing connections with cells may be communicated.

Note that the downlink, the uplink, and so on in the present disclosure may be expressed without a term of “link.” In addition, various channels may be expressed without adding “Physical” to the head.

In the radio communication system 1, a synchronization signal (SS), a downlink reference signal (DL-RS), and so on may be communicated. In the radio communication system 1, a cell-specific reference signal (CRS), a channel state information-reference signal (CSI-RS), a demodulation reference signal (DMRS), a positioning reference signal (PRS), a phase tracking reference signal (PTRS), and so on may be communicated as the DL-RS.

For example, the synchronization signal may be at least one of a primary synchronization signal (PSS) and a secondary synchronization signal (SSS). A signal block including an SS (PSS, SSS) and a PBCH (and a DMRS for a PBCH) may be referred to as an “SS/PBCH block,” an “SS Block (SSB),” and so on. Note that an SS, an SSB, and so on may be also referred to as a “reference signal.”

In the radio communication system 1, a sounding reference signal (SRS), a demodulation reference signal (DMRS), and so on may be communicated as an uplink reference signal (UL-RS). Note that DMRS may be referred to as a “user terminal specific reference signal (UE-specific Reference Signal).”

### (Base Station)

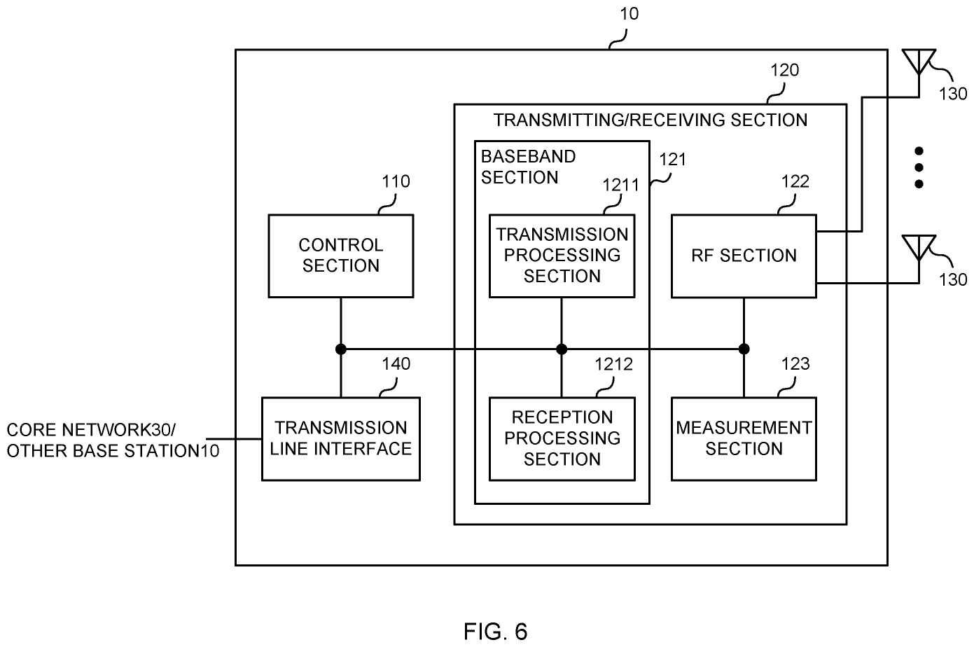

FIG. 6 is a diagram to show an example of a structure of the base station according to one embodiment. The base station 10 includes a control section 110, a transmitting/receiving section 120, transmitting/receiving antennas 130 and a communication path interface (transmission line interface) 140. Note that the base station 10 may include one or more control sections 110, one or more transmitting/receiving sections 120, one or more transmitting/receiving antennas 130, and one or more communication path interfaces 140.

Note that, the present example primarily shows functional blocks that pertain to characteristic parts of the present embodiment, and it is assumed that the base station 10 may include other functional blocks that are necessary for radio communication as well. Part of the processes of each section described below may be omitted.

The control section 110 controls the whole of the base station 10. The control section 110 can be constituted with a controller, a control circuit, or the like described based on general understanding of the technical field to which the present disclosure pertains.

The control section 110 may control generation of signals, scheduling (for example, resource allocation, mapping), and so on. The control section 110 may control transmission and reception, measurement and so on using the transmitting/receiving section 120, the transmitting/receiving antennas 130, and the communication path interface 140. The control section 110 may generate data, control information, a sequence and so on to transmit as a signal, and forward the generated items to the transmitting/receiving section 120. The control section 110 may perform call processing (setting up, releasing) for communication channels, manage the state of the base station 10, and manage the radio resources.

The transmitting/receiving section 120 may include a baseband section 121, a Radio Frequency (RF) section 122, and a measurement section 123. The baseband section 121 may include a transmission processing section 1211 and a reception processing section 1212. The transmitting/receiving section 120 can be constituted with a transmitter/receiver, an RF circuit, a baseband circuit, a filter, a phase shifter, a measurement circuit, a transmitting/receiving circuit, or the like described based on general understanding of the technical field to which the present disclosure pertains.

The transmitting/receiving section 120 may be structured as a transmitting/receiving section in one entity, or may be constituted with a transmitting section and a receiving section. The transmitting section may be constituted with the transmission processing section 1211, and the RF section 122. The receiving section may be constituted with the reception processing section 1212, the RF section 122, and the measurement section 123.

The transmitting/receiving antennas 130 can be constituted with antennas, for example, an array antenna, or the like described based on general understanding of the technical field to which the present disclosure pertains.

The transmitting/receiving section 120 may transmit the above-described downlink channel, synchronization signal, downlink reference signal, and so on. The transmitting/receiving section 120 may receive the above-described uplink channel, uplink reference signal, and so on.

The transmitting/receiving section 120 may form at least one of a transmit beam and a receive beam by using digital beam forming (for example, precoding), analog beam forming (for example, phase rotation), and so on.

The transmitting/receiving section 120 (transmission processing section 1211) may perform the processing of the Packet Data Convergence Protocol (PDCP) layer, the processing of the Radio Link Control (RLC) layer (for example, RLC retransmission control), the processing of the Medium Access Control (MAC) layer (for example, HARQ retransmission control), and so on, for example, on data and control information and so on acquired from the control section 110, and may generate bit string to transmit.

The transmitting/receiving section 120 (transmission processing section 1211) may perform transmission processing such as channel coding (which may include error correction coding), modulation, mapping, filtering, discrete Fourier transform (DFT) processing (as necessary), inverse fast Fourier transform (IFFT) processing, precoding, digital-to-analog conversion, and so on, on the bit string to transmit, and output a baseband signal.

The transmitting/receiving section 120 (RF section 122) may perform modulation to a radio frequency band, filtering, amplification, and so on, on the baseband signal, and transmit the signal of the radio frequency band through the transmitting/receiving antennas 130.

On the other hand, the transmitting/receiving section 120 (RF section 122) may perform amplification, filtering, demodulation to a baseband signal, and so on, on the signal of the radio frequency band received by the transmitting/receiving antennas 130.

The transmitting/receiving section 120 (reception processing section 1212) may apply reception processing such as analog-digital conversion, fast Fourier transform (FFT) processing, inverse discrete Fourier transform (IDFT) processing (as necessary), filtering, de-mapping, demodulation, decoding (which may include error correction decoding), MAC layer processing, the processing of the RLC layer and the processing of the PDCP layer, and so on, on the acquired baseband signal, and acquire user data, and so on.

The transmitting/receiving section 120 (measurement section 123) may perform the measurement related to the received signal. For example, the measurement section 123 may perform Radio Resource Management (RRM) measurement, Channel State Information (CSI) measurement, and so on, based on the received signal. The measurement section 123 may measure a received power (for example, Reference Signal Received Power (RSRP)), a received quality (for example, Reference Signal Received Quality (RSRQ), a Signal to Interference plus Noise Ratio (SINR), a Signal to Noise Ratio (SNR)), a signal strength (for example, Received Signal Strength Indicator (RSSI)), channel information (for example, CSI), and so on. The measurement results may be output to the control section 110.

The communication path interface 140 may perform transmission/reception (backhaul signaling) of a signal with an apparatus included in the core network 30 or other base stations 10, and so on, and acquire or transmit user data (user plane data), control plane data, and so on for the user terminal 20.

Note that the transmitting section and the receiving section of the base station 10 in the present disclosure may be constituted with at least one of the transmitting/receiving section 120, the transmitting/receiving antennas 130, and the communication path interface 140.

Note that the transmitting/receiving section 120 may transmit information for indicating at least one of a first Transmission Configuration Indication state (TCI) state common to both downlink (DL) and uplink (UL), a second TCI state common to the DL, and a third TCI state common to the UL, the first TCI state, the second TCI state, and the third TCI state being associated with another cell having a physical cell ID different from a physical cell ID of a serving cell.

When at least one of the first TCI state, the second TCI state, and the third TCI state indicated in the information is applied to a specific channel for such another cell, the control section 110 may control at least one of transmission and reception of the specific channel.

### (User Terminal)

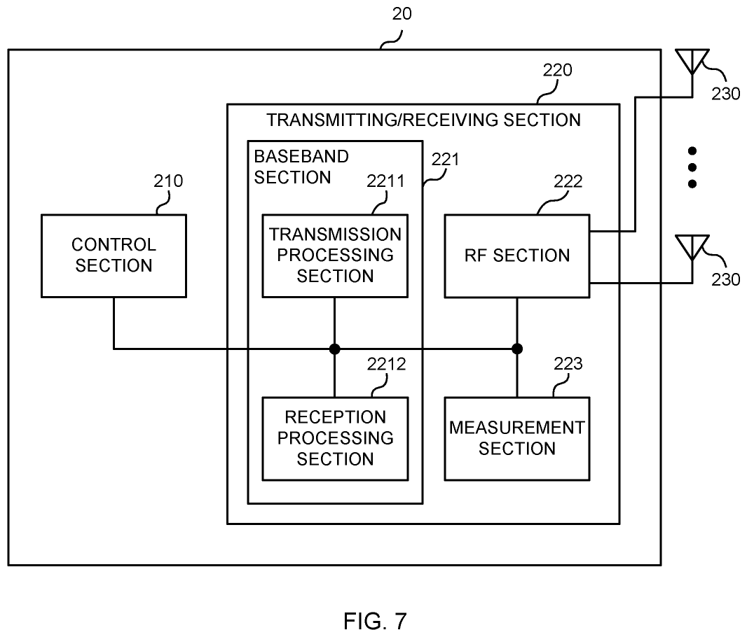

FIG. 7 is a diagram to show an example of a structure of the user terminal according to one embodiment. The user terminal 20 includes a control section 210, a transmitting/receiving section 220, and transmitting/receiving antennas 230. Note that the user terminal 20 may include one or more control sections 210, one or more transmitting/receiving sections 220, and one or more transmitting/receiving antennas 230.

Note that, the present example primarily shows functional blocks that pertain to characteristic parts of the present embodiment, and it is assumed that the user terminal 20 may include other functional blocks that are necessary for radio communication as well. Part of the processes of each section described below may be omitted.

The control section 210 controls the whole of the user terminal 20. The control section 210 can be constituted with a controller, a control circuit, or the like described based on general understanding of the technical field to which the present disclosure pertains.

The control section 210 may control generation of signals, mapping, and so on. The control section 210 may control transmission/reception, measurement and so on using the transmitting/receiving section 220, and the transmitting/receiving antennas 230. The control section 210 generates data, control information, a sequence and so on to transmit as a signal, and may forward the generated items to the transmitting/receiving section 220.

The transmitting/receiving section 220 may include a baseband section 221, an RF section 222, and a measurement section 223. The baseband section 221 may include a transmission processing section 2211 and a reception processing section 2212. The transmitting/receiving section 220 can be constituted with a transmitter/receiver, an RF circuit, a baseband circuit, a filter, a phase shifter, a measurement circuit, a transmitting/receiving circuit, or the like described based on general understanding of the technical field to which the present disclosure pertains.

The transmitting/receiving section 220 may be structured as a transmitting/receiving section in one entity, or may be constituted with a transmitting section and a receiving section. The transmitting section may be constituted with the transmission processing section 2211, and the RF section 222. The receiving section may be constituted with the reception processing section 2212, the RF section 222, and the measurement section 223.

The transmitting/receiving antennas 230 can be constituted with antennas, for example, an array antenna, or the like described based on general understanding of the technical field to which the present disclosure pertains.

The transmitting/receiving section 220 may receive the above-described downlink channel, synchronization signal, downlink reference signal, and so on. The transmitting/receiving section 220 may transmit the above-described uplink channel, uplink reference signal, and so on.

The transmitting/receiving section 220 may form at least one of a transmit beam and a receive beam by using digital beam forming (for example, precoding), analog beam forming (for example, phase rotation), and so on.

The transmitting/receiving section 220 (transmission processing section 2211) may perform the processing of the PDCP layer, the processing of the RLC layer (for example, RLC retransmission control), the processing of the MAC layer (for example, HARQ retransmission control), and so on, for example, on data and control information and so on acquired from the control section 210, and may generate bit string to transmit.

The transmitting/receiving section 220 (transmission processing section 2211) may perform transmission processing such as channel coding (which may include error correction coding), modulation, mapping, filtering, DFT processing (as necessary), IFFT processing, precoding, digital-to-analog conversion, and so on, on the bit string to transmit, and output a baseband signal.

Note that, whether to apply DFT processing or not may be based on the configuration of the transform precoding. The transmitting/receiving section 220 (transmission processing section 2211) may perform, for a certain channel (for example, PUSCH), the DFT processing as the above-described transmission processing to transmit the channel by using a DFT-s-OFDM waveform if transform precoding is enabled, and otherwise, does not need to perform the DFT processing as the above-described transmission process.

The transmitting/receiving section 220 (RF section 222) may perform modulation to a radio frequency band, filtering, amplification, and so on, on the baseband signal, and transmit the signal of the radio frequency band through the transmitting/receiving antennas 230.

On the other hand, the transmitting/receiving section 220 (RF section 222) may perform amplification, filtering, demodulation to a baseband signal, and so on, on the signal of the radio frequency band received by the transmitting/receiving antennas 230.

The transmitting/receiving section 220 (reception processing section 2212) may apply a receiving process such as analog-digital conversion, FFT processing, IDFT processing (as necessary), filtering, de-mapping, demodulation, decoding (which may include error correction decoding), MAC layer processing, the processing of the RLC layer and the processing of the PDCP layer, and so on, on the acquired baseband signal, and acquire user data, and so on.

The transmitting/receiving section 220 (measurement section 223) may perform the measurement related to the received signal. For example, the measurement section 223 may perform RRM measurement, CSI measurement, and so on, based on the received signal. The measurement section 223 may measure a received power (for example, RSRP), a received quality (for example, RSRQ, SINR, SNR), a signal strength (for example, RSSI), channel information (for example, CSI), and so on. The measurement results may be output to the control section 210.

Note that the transmitting section and the receiving section of the user terminal 20 in the present disclosure may be constituted with at least one of the transmitting/receiving section 220 and the transmitting/receiving antennas 230.

Note that the transmitting/receiving section 220 may receive information for indicating at least one of a first Transmission Configuration Indication state (TCI) state common to both downlink (DL) and uplink (UL), a second TCI state common to the DL, and a third TCI state common to the UL, the first TCI state, the second TCI state, and the third TCI state being associated with another cell having a physical cell ID different from a physical cell ID of a serving cell.

The control section 210 may apply, to a specific channel for such another cell, at least one of the first TCI state, the second TCI state, and the third TCI state indicated in the information.

When at least one of the first TCI state, the second TCI state, and the third TCI state is indicated for a specific control resource set, the control section 210 may judge that the serving cell is changed to such another cell.

The transmitting/receiving section 220 may receive a Medium Access Control Control Element (MAC CE) including a field indicating whether to change the serving cell. The control section 210 may judge, on the basis of the field, whether the serving cell is changed to such another cell.

The control section 210 may change a configuration of the serving cell to a configuration of such another cell on the basis of a configuration received with higher layer signaling.

### (Hardware Structure)

Note that the block diagrams that have been used to describe the above embodiments show blocks in functional units. These functional blocks (components) may be implemented in arbitrary combinations of at least one of hardware and software. Also, the method for implementing each functional block is not particularly limited. That is, each functional block may be realized by one piece of apparatus that is physically or logically coupled, or may be realized by directly or indirectly connecting two or more physically or logically separate pieces of apparatus (for example, via wire, wireless, or the like) and using these plurality of pieces of apparatus. The functional blocks may be implemented by combining softwares into the apparatus described above or the plurality of apparatuses described above.

Here, functions include judgment, determination, decision, calculation, computation, processing, derivation, investigation, search, confirmation, reception, transmission, output, access, resolution, selection, designation, establishment, comparison, assumption, expectation, considering, broadcasting, notifying, communicating, forwarding, configuring, reconfiguring, allocating (mapping), assigning, and the like, but function are by no means limited to these. For example, functional block (components) to implement a function of transmission may be referred to as a “transmitting section (transmitting unit),” a “transmitter,” and the like. The method for implementing each component is not particularly limited as described above.

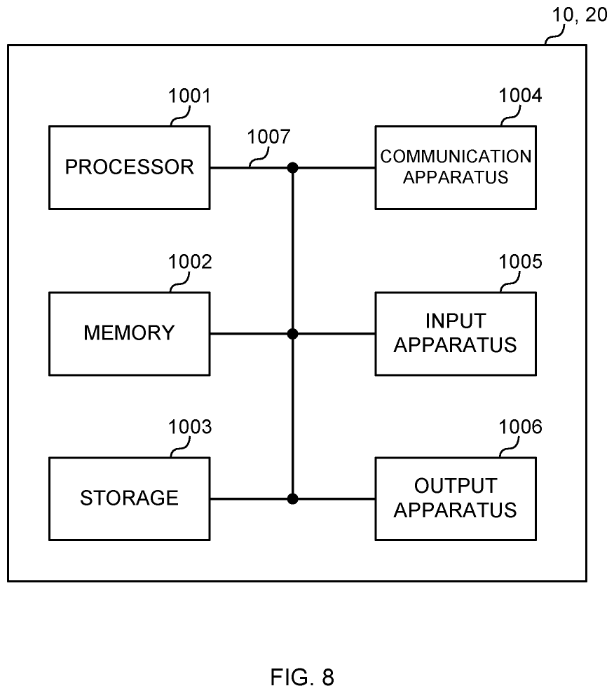

For example, a base station, a user terminal, and so on according to one embodiment of the present disclosure may function as a computer that executes the processes of the radio communication method of the present disclosure. FIG. 8 is a diagram to show an example of a hardware structure of the base station and the user terminal according to one embodiment. Physically, the above-described base station 10 and user terminal 20 may each be formed as a computer apparatus that includes a processor 1001, a memory 1002, a storage 1003, a communication apparatus 1004, an input apparatus 1005, an output apparatus 1006, a bus 1007, and so on.

Note that in the present disclosure, the words such as an apparatus, a circuit, a device, a section, a unit, and so on can be interchangeably interpreted. The hardware structure of the base station 10 and the user terminal 20 may be configured to include one or more of apparatuses shown in the drawings, or may be configured not to include part of apparatuses.

For example, although only one processor 1001 is shown, a plurality of processors may be provided. Furthermore, processes may be implemented with one processor or may be implemented at the same time, in sequence, or in different manners with two or more processors. Note that the processor 1001 may be implemented with one or more chips.

Each function of the base station 10 and the user terminals 20 is implemented, for example, by allowing certain software (programs) to be read on hardware such as the processor 1001 and the memory 1002, and by allowing the processor 1001 to perform calculations to control communication via the communication apparatus 1004 and control at least one of reading and writing of data in the memory 1002 and the storage 1003.

The processor 1001 controls the whole computer by, for example, running an operating system. The processor 1001 may be configured with a central processing unit (CPU), which includes interfaces with peripheral apparatus, control apparatus, computing apparatus, a register, and so on. For example, at least part of the above-described control section 110 (210), the transmitting/receiving section 120 (220), and so on may be implemented by the processor 1001.

Furthermore, the processor 1001 reads programs (program codes), software modules, data, and so on from at least one of the storage 1003 and the communication apparatus 1004, into the memory 1002, and executes various processes according to these. As for the programs, programs to allow computers to execute at least part of the operations of the above-described embodiments are used. For example, the control section 110 (210) may be implemented by control programs that are stored in the memory 1002 and that operate on the processor 1001, and other functional blocks may be implemented likewise.

The memory 1002 is a computer-readable recording medium, and may be constituted with, for example, at least one of a Read Only Memory (ROM), an Erasable Programmable ROM (EPROM), an Electrically EPROM (EEPROM), a Random Access Memory (RAM), and other appropriate storage media. The memory 1002 may be referred to as a “register,” a “cache,” a “main memory (primary storage apparatus)” and so on. The memory 1002 can store executable programs (program codes), software modules, and the like for implementing the radio communication method according to one embodiment of the present disclosure.

The storage 1003 is a computer-readable recording medium, and may be constituted with, for example, at least one of a flexible disk, a floppy (registered trademark) disk, a magneto-optical disk (for example, a compact disc (Compact Disc ROM (CD-ROM) and so on), a digital versatile disc, a Blu-ray (registered trademark) disk), a removable disk, a hard disk drive, a smart card, a flash memory device (for example, a card, a stick, and a key drive), a magnetic stripe, a database, a server, and other appropriate storage media. The storage 1003 may be referred to as “secondary storage apparatus.”

The communication apparatus 1004 is hardware (transmitting/receiving device) for allowing inter-computer communication via at least one of wired and wireless networks, and may be referred to as, for example, a “network device,” a “network controller,” a “network card,” a “communication module,” and so on. The communication apparatus 1004 may be configured to include a high frequency switch, a duplexer, a filter, a frequency synthesizer, and so on in order to realize, for example, at least one of frequency division duplex (FDD) and time division duplex (TDD). For example, the above-described transmitting/receiving section 120 (220), the transmitting/receiving antennas 130 (230), and so on may be implemented by the communication apparatus 1004. In the transmitting/receiving section 120 (220), the transmitting section 120a (220a) and the receiving section 120b (220b) can be implemented while being separated physically or logically.

The input apparatus 1005 is an input device that receives input from the outside (for example, a keyboard, a mouse, a microphone, a switch, a button, a sensor, and so on). The output apparatus 1006 is an output device that allows sending output to the outside (for example, a display, a speaker, a Light Emitting Diode (LED) lamp, and so on). Note that the input apparatus 1005 and the output apparatus 1006 may be provided in an integrated structure (for example, a touch panel).

Furthermore, these types of apparatus, including the processor 1001, the memory 1002, and others, are connected by a bus 1007 for communicating information. The bus 1007 may be formed with a single bus, or may be formed with buses that vary between pieces of apparatus.

Also, the base station 10 and the user terminals 20 may be structured to include hardware such as a microprocessor, a digital signal processor (DSP), an Application Specific Integrated Circuit (ASIC), a Programmable Logic Device (PLD), a Field Programmable Gate Array (FPGA), and so on, and part or all of the functional blocks may be implemented by the hardware. For example, the processor 1001 may be implemented with at least one of these pieces of hardware.

### (Variations)

Note that the terminology described in the present disclosure and the terminology that is needed to understand the present disclosure may be replaced by other terms that convey the same or similar meanings. For example, a “channel,” a “symbol,” and a “signal” (or signaling) may be interchangeably interpreted. Also, “signals” may be “messages.” A reference signal may be abbreviated as an “RS,” and may be referred to as a “pilot,” a “pilot signal,” and so on, depending on which standard applies. Furthermore, a “component carrier (CC)” may be referred to as a “cell,” a “frequency carrier,” a “carrier frequency” and so on.

A radio frame may be constituted of one or a plurality of periods (frames) in the time domain. Each of one or a plurality of periods (frames) constituting a radio frame may be referred to as a “subframe.” Furthermore, a subframe may be constituted of one or a plurality of slots in the time domain. A subframe may be a fixed time length (for example, 1 ms) independent of numerology.

Here, numerology may be a communication parameter applied to at least one of transmission and reception of a certain signal or channel. For example, numerology may indicate at least one of a subcarrier spacing (SCS), a bandwidth, a symbol length, a cyclic prefix length, a transmission time interval (TTI), the number of symbols per TTI, a radio frame structure, a particular filter processing performed by a transceiver in the frequency domain, a particular windowing processing performed by a transceiver in the time domain, and so on.

A slot may be constituted of one or a plurality of symbols in the time domain (Orthogonal Frequency Division Multiplexing (OFDM) symbols, Single Carrier Frequency Division Multiple Access (SC-FDMA) symbols, and so on). Furthermore, a slot may be a time unit based on numerology.

A slot may include a plurality of mini-slots. Each mini-slot may be constituted of one or a plurality of symbols in the time domain. A mini-slot may be referred to as a “sub-slot.” A mini-slot may be constituted of symbols less than the number of slots. A PDSCH (or PUSCH) transmitted in a time unit larger than a mini-slot may be referred to as “PDSCH (PUSCH) mapping type A.” A PDSCH (or PUSCH) transmitted using a mini-slot may be referred to as “PDSCH (PUSCH) mapping type B.”

A radio frame, a subframe, a slot, a mini-slot, and a symbol all express time units in signal communication. A radio frame, a subframe, a slot, a mini-slot, and a symbol may each be called by other applicable terms. Note that time units such as a frame, a subframe, a slot, mini-slot, and a symbol in the present disclosure may be interchangeably interpreted.

For example, one subframe may be referred to as a “TTI,” a plurality of consecutive subframes may be referred to as a “TTI,” or one slot or one mini-slot may be referred to as a “TTI.” That is, at least one of a subframe and a TTI may be a subframe (1 ms) in existing LTE, may be a shorter period than 1 ms (for example, 1 to 13 symbols), or may be a longer period than 1 ms. Note that a unit expressing TTI may be referred to as a “slot,” a “mini-slot,” and so on instead of a “subframe.”

Here, a TTI refers to the minimum time unit of scheduling in radio communication, for example. For example, in LTE systems, a base station schedules the allocation of radio resources (such as a frequency bandwidth and transmit power that are available for each user terminal) for the user terminal in TTI units. Note that the definition of TTIs is not limited to this.

TTIs may be transmission time units for channel-encoded data packets (transport blocks), code blocks, or codewords, or may be the unit of processing in scheduling, link adaptation, and so on. Note that, when TTIs are given, the time interval (for example, the number of symbols) to which transport blocks, code blocks, codewords, or the like are actually mapped may be shorter than the TTIS.

Note that, in the case where one slot or one mini-slot is referred to as a TTI, one or more TTIs (that is, one or more slots or one or more mini-slots) may be the minimum time unit of scheduling. Furthermore, the number of slots (the number of mini-slots) constituting the minimum time unit of the scheduling may be controlled.

A TTI having a time length of 1 ms may be referred to as a “normal TTI” (TTI in 3GPP Rel. 8 to Rel. 12), a “long TTI,” a “normal subframe,” a “long subframe,” a “slot” and so on. A TTI that is shorter than a normal TTI may be referred to as a “shortened TTI,” a “short TTI,” a “partial or fractional TTI,” a “shortened subframe,” a “short subframe,” a “mini-slot,” a “sub-slot,” a “slot” and so on.

Note that a long TTI (for example, a normal TTI, a subframe, and so on) may be interpreted as a TTI having a time length exceeding 1 ms, and a short TTI (for example, a shortened TTI and so on) may be interpreted as a TTI having a TTI length shorter than the TTI length of a long TTI and equal to or longer than 1 ms.

A resource block (RB) is the unit of resource allocation in the time domain and the frequency domain, and may include one or a plurality of consecutive subcarriers in the frequency domain. The number of subcarriers included in an RB may be the same regardless of numerology, and, for example, may be 12. The number of subcarriers included in an RB may be determined based on numerology.

Also, an RB may include one or a plurality of symbols in the time domain, and may be one slot, one mini-slot, one subframe, or one TTI in length. One TTI, one subframe, and so on each may be constituted of one or a plurality of resource blocks.

Note that one or a plurality of RBs may be referred to as a “physical resource block (Physical RB (PRB)),” a “sub-carrier group (SCG),” a “resource element group (REG),” a “PRB pair,” an “RB pair” and so on.

Furthermore, a resource block may be constituted of one or a plurality of resource elements (REs). For example, one RE may correspond to a radio resource field of one subcarrier and one symbol.

A bandwidth part (BWP) (which may be referred to as a “fractional bandwidth,” and so on) may represent a subset of contiguous common resource blocks (common RBs) for certain numerology in a certain carrier. Here, a common RB may be specified by an index of the RB based on the common reference point of the carrier. A PRB may be defined by a certain BWP and may be numbered in the BWP.

The BWP may include a UL BWP (BWP for the UL) and a DL BWP (BWP for the DL). One or a plurality of BWPs may be configured in one carrier for a UE.

At least one of configured BWPs may be active, and a UE does not need to assume to transmit/receive a certain signal/channel outside active BWPs. Note that a “cell,” a “carrier,” and so on in the present disclosure may be interpreted as a “BWP”.

Note that the above-described structures of radio frames, subframes, slots, mini-slots, symbols, and so on are merely examples. For example, structures such as the number of subframes included in a radio frame, the number of slots per subframe or radio frame, the number of mini-slots included in a slot, the numbers of symbols and RBs included in a slot or a mini-slot, the number of subcarriers included in an RB, the number of symbols in a TTI, the symbol length, the cyclic prefix (CP) length, and so on can be variously changed.

Also, the information, parameters, and so on described in the present disclosure may be represented in absolute values or in relative values with respect to certain values, or may be represented in another corresponding information. For example, radio resources may be specified by certain indices.

The names used for parameters and so on in the present disclosure are in no respect limiting. Furthermore, mathematical expressions that use these parameters, and so on may be different from those expressly disclosed in the present disclosure. For example, since various channels (PUCCH, PDCCH, and so on) and information elements can be identified by any suitable names, the various names allocated to these various channels and information elements are in no respect limiting.

The information, signals, and so on described in the present disclosure may be represented by using any of a variety of different technologies. For example, data, instructions, commands, information, signals, bits, symbols, chips, and so on, all of which may be referenced throughout the herein-contained description, may be represented by voltages, currents, electromagnetic waves, magnetic fields or particles, optical fields or photons, or any combination of these.

Also, information, signals, and so on can be output in at least one of from higher layers to lower layers and from lower layers to higher layers. Information, signals, and so on may be input and/or output via a plurality of network nodes.

The information, signals, and so on that are input and/or output may be stored in a specific location (for example, a memory) or may be managed by using a management table. The information, signals, and so on to be input and/or output can be overwritten, updated, or appended. The information, signals, and so on that are output may be deleted. The information, signals, and so on that are input may be transmitted to another apparatus.

Reporting of information is by no means limited to the aspects/embodiments described in the present disclosure, and other methods may be used as well. For example, reporting of information in the present disclosure may be implemented by using physical layer signaling (for example, downlink control information (DCI), uplink control information (UCI), higher layer signaling (for example, Radio Resource Control (RRC) signaling, broadcast information (master information block (MIB), system information blocks (SIBs), and so on), Medium Access Control (MAC) signaling and so on), and other signals or combinations of these.

Note that physical layer signaling may be referred to as “Layer 1/Layer 2 (L1/L2) control information (L1/L2 control signals),” “L1 control information (L1 control signal),” and so on. Also, RRC signaling may be referred to as an “RRC message,” and can be, for example, an RRC connection setup message, an RRC connection reconfiguration message, and so on. Also, MAC signaling may be reported using, for example, MAC control elements (MAC CEs).

Also, reporting of certain information (for example, reporting of “X holds”) does not necessarily have to be reported explicitly, and can be reported implicitly (by, for example, not reporting this certain information or reporting another piece of information).

Determinations may be made in values represented by one bit (0 or 1), may be made in Boolean values that represent true or false, or may be made by comparing numerical values (for example, comparison against a certain value).

Software, whether referred to as “software,” “firmware,” “middleware,” “microcode,” or “hardware description language,” or called by other terms, should be interpreted broadly to mean instructions, instruction sets, code, code segments, program codes, programs, subprograms, software modules, applications, software applications, software packages, routines, subroutines, objects, executable files, execution threads, procedures, functions, and so on.

Also, software, commands, information, and so on may be transmitted and received via communication media. For example, when software is transmitted from a website, a server, or other remote sources by using at least one of wired technologies (coaxial cables, optical fiber cables, twisted-pair cables, digital subscriber lines (DSL), and so on) and wireless technologies (infrared radiation, microwaves, and so on), at least one of these wired technologies and wireless technologies are also included in the definition of communication media.

The terms “system” and “network” used in the present disclosure can be used interchangeably. The “network” may mean an apparatus (for example, a base station) included in the network.

In the present disclosure, the terms such as “precoding,” a “precoder,” a “weight (precoding weight),” “quasi-co-location (QCL),” a “Transmission Configuration Indication state (TCI state),” a “spatial relation,” a “spatial domain filter,” a “transmit power,” “phase rotation,” an “antenna port,” an “antenna port group,” a “layer,” “the number of layers,” a “rank,” a “resource,” a “resource set,” a “resource group,” a “beam,” a “beam width,” a “beam angular degree,” an “antenna,” an “antenna element,” a “panel,” and so on can be used interchangeably.

In the present disclosure, the terms such as a “base station (BS),” a “radio base station,” a “fixed station,” a “NodeB,” an “eNB (eNodeB),” a “gNB (gNodeB),” an “access point,” a “transmission point (TP),” a “reception point (RP),” a “transmission/reception point (TRP),” a “panel,” a “cell,” a “sector,” a “cell group,” a “carrier,” a “component carrier,” and so on can be used interchangeably. The base station may be referred to as the terms such as a “macro cell,” a small cell,” a “femto cell,” a “pico cell,” and so on.

A base station can accommodate one or a plurality of (for example, three) cells. When a base station accommodates a plurality of cells, the entire coverage area of the base station can be partitioned into multiple smaller areas, and each smaller area can provide communication services through base station subsystems (for example, indoor small base stations (Remote Radio Heads (RRHs))). The term “cell” or “sector” refers to part of or the entire coverage area of at least one of a base station and a base station subsystem that provides communication services within this coverage.

In the present disclosure, the terms “mobile station (MS),” “user terminal,” “user equipment (UE),” and “terminal” may be used interchangeably.

A mobile station may be referred to as a “subscriber station,” “mobile unit,” “subscriber unit,” “wireless unit,” “remote unit,” “mobile device,” “wireless device,” “wireless communication device,” “remote device,” “mobile subscriber station,” “access terminal,” “mobile terminal,” “wireless terminal,” “remote terminal,” “handset,” “user agent,” “mobile client,” “client,” or some other appropriate terms in some cases.

At least one of a base station and a mobile station may be referred to as a “transmitting apparatus,” a “receiving apparatus,” a “radio communication apparatus,” and so on. Note that at least one of a base station and a mobile station may be device mounted on a mobile body or a mobile body itself, and so on. The mobile body may be a vehicle (for example, a car, an airplane, and the like), may be a mobile body which moves unmanned (for example, a drone, an automatic operation car, and the like), or may be a robot (a manned type or unmanned type). Note that at least one of a base station and a mobile station also includes an apparatus which does not necessarily move during communication operation. For example, at least one of a base station and a mobile station may be an Internet of Things (IoT) device such as a sensor, and the like.

Furthermore, the base station in the present disclosure may be interpreted as a user terminal. For example, each aspect/embodiment of the present disclosure may be applied to the structure that replaces a communication between a base station and a user terminal with a communication between a plurality of user terminals (for example, which may be referred to as “Device-to-Device (D2D),” “Vehicle-to-Everything (V2X),” and the like). In this case, user terminals 20 may have the functions of the base stations 10 described above. The words “uplink” and “downlink” may be interpreted as the words corresponding to the terminal-to-terminal communication (for example, “sidelink”). For example, an uplink channel, a downlink channel and so on may be interpreted as a sidelink channel.

Likewise, the user terminal in the present disclosure may be interpreted as base station. In this case, the base station 10 may have the functions of the user terminal 20 described above.

Actions which have been described in the present disclosure to be performed by a base station may, in some cases, be performed by upper nodes. In a network including one or a plurality of network nodes with base stations, it is clear that various operations that are performed to communicate with terminals can be performed by base stations, one or more network nodes (for example, Mobility Management Entities (MMEs), Serving-Gateways (S-GWs), and so on may be possible, but these are not limiting) other than base stations, or combinations of these.

The aspects/embodiments illustrated in the present disclosure may be used individually or in combinations, which may be switched depending on the mode of implementation. The order of processes, sequences, flowcharts, and so on that have been used to describe the aspects/embodiments in the present disclosure may be re-ordered as long as inconsistencies do not arise. For example, although various methods have been illustrated in the present disclosure with various components of steps in exemplary orders, the specific orders that are illustrated herein are by no means limiting.

The aspects/embodiments illustrated in the present disclosure may be applied to Long Term Evolution (LTE), LTE-Advanced (LTE-A), LTE-Beyond (LTE-B), SUPER 3G, IMT-Advanced, 4th generation mobile communication system (4G), 5th generation mobile communication system (5G), 6th generation mobile communication system (6G), xth generation mobile communication system (xG) (xG (where x is, for example, an integer or a decimal)), Future Radio Access (FRA), New-Radio Access Technology (RAT), New Radio (NR), New radio access (NX), Future generation radio access (FX), Global System for Mobile communications (GSM (registered trademark)), CDMA 2000, Ultra Mobile Broadband (UMB), IEEE 802.11 (Wi-Fi (registered trademark)), IEEE 802.16 (WiMAX (registered trademark)), IEEE 802.20, Ultra-WideBand (UWB), Bluetooth (registered trademark), systems that use other adequate radio communication methods and next-generation systems that are enhanced based on these. A plurality of systems may be combined (for example, a combination of LTE or LTE-A and 5G, and the like) and applied.

The phrase “based on” (or “on the basis of”) as used in the present disclosure does not mean “based only on” (or “only on the basis of”), unless otherwise specified. In other words, the phrase “based on” (or “on the basis of”) means both “based only on” and “based at least on” (“only on the basis of” and “at least on the basis of”).

Reference to elements with designations such as “first,” “second,” and so on as used in the present disclosure does not generally limit the quantity or order of these elements. These designations may be used in the present disclosure only for convenience, as a method for distinguishing between two or more elements. Thus, reference to the first and second elements does not imply that only two elements may be employed, or that the first element must precede the second element in some way.

The term “judging (determining)” as in the present disclosure herein may encompass a wide variety of actions. For example, “judging (determining)” may be interpreted to mean making “judgments (determinations)” about judging, calculating, computing, processing, deriving, investigating, looking up, search and inquiry (for example, searching a table, a database, or some other data structures), ascertaining, and so on.

Furthermore, “judging (determining)” may be interpreted to mean making “judgments (determinations)” about receiving (for example, receiving information), transmitting (for example, transmitting information), input, output, accessing (for example, accessing data in a memory), and so on.

In addition, “judging (determining)” as used herein may be interpreted to mean making “judgments (determinations)” about resolving, selecting, choosing, establishing, comparing, and so on. In other words, “judging (determining)” may be interpreted to mean making “judgments (determinations)” about some action.

In addition, “judging (determining)” may be interpreted as “assuming,” “expecting,” “considering,” and the like.

The terms “connected” and “coupled,” or any variation of these terms as used in the present disclosure mean all direct or indirect connections or coupling between two or more elements, and may include the presence of one or more intermediate elements between two elements that are “connected” or “coupled” to each other. The coupling or connection between the elements may be physical, logical, or a combination thereof. For example, “connection” may be interpreted as “access.”

In the present disclosure, when two elements are connected, the two elements may be considered “connected” or “coupled” to each other by using one or more electrical wires, cables and printed electrical connections, and, as some non-limiting and non-inclusive examples, by using electromagnetic energy having wavelengths in radio frequency regions, microwave regions, (both visible and invisible) optical regions, or the like.

In the present disclosure, the phrase “A and B are different” may mean that “A and B are different from each other.” Note that the phrase may mean that “A and B is each different from C.” The terms “separate,” “be coupled,” and so on may be interpreted similarly to “different.”

When terms such as “include,” “including,” and variations of these are used in the present disclosure, these terms are intended to be inclusive, in a manner similar to the way the term “comprising” is used. Furthermore, the term “or” as used in the present disclosure is intended to be not an exclusive disjunction.

For example, in the present disclosure, when an article such as “a,” “an,” and “the” in the English language is added by translation, the present disclosure may include that a noun after these articles is in a plural form.

Now, although the invention according to the present disclosure has been described in detail above, it should be obvious to a person skilled in the art that the invention according to the present disclosure is by no means limited to the embodiments described in the present disclosure. The invention according to the present disclosure can be implemented with various corrections and in various modifications, without departing from the spirit and scope of the invention defined by the recitations of claims. Consequently, the description of the present disclosure is provided only for the purpose of explaining examples, and should by no means be construed to limit the invention according to the present disclosure in any way.

1. A terminal comprising:
a receiving section that receives information for indicating at least one of a first Transmission Configuration Indication state (TCI) state common to both downlink (DL) and uplink (UL), a second TCI state common to the DL, and a third TCI state common to the UL, the first TCI state, the second TCI state, and the third TCI state being associated with a certain cell that is other than a serving cell and has a physical cell ID different from a physical cell ID of the serving cell; and
a control section that applies, to a specific channel for the certain cell, at least one of the first TCI state, the second TCI state, and the third TCI state indicated in the information.

2. The terminal according to claim 1, wherein
when at least one of the first TCI state, the second TCI state, and the third TCI state is indicated for a specific control resource set, the control section judges that the serving cell is changed to the certain cell.

3. The terminal according to claim 1, wherein
the receiving section receives a Medium Access Control Control Element (MAC CE) including a field indicating whether to change the serving cell, and
the control section judges, on the basis of the field, whether to change the serving cell to the certain cell.

4. The terminal according to claim 1, wherein
the control section changes a configuration of the serving cell to a configuration of the certain cell on the basis of a configuration received with higher layer signaling.

5. A radio communication method for a terminal, the radio communication method comprising:
receiving information for indicating at least one of a first Transmission Configuration Indication state (TCI) state common to both downlink (DL) and uplink (UL), a second TCI state common to the DL, and a third TCI state common to the UL, the first TCI state, the second TCI state, and the third TCI state being associated with a certain cell that is other than a serving cell and has a physical cell ID different from a physical cell ID of the serving cell; and
applying, to a specific channel for the certain cell, at least one of the first TCI state, the second TCI state, and the third TCI state indicated in the information.

6. A base station comprising:
a transmitting section that transmits information for indicating at least one of a first Transmission Configuration Indication state (TCI) state common to both downlink (DL) and uplink (UL), a second TCI state common to the DL, and a third TCI state common to the UL, the first TCI state, the second TCI state, and the third TCI state being associated with a certain cell that is other than a serving cell and has a physical cell ID different from a physical cell ID of the serving cell; and
a control section that, when at least one of the first TCI state, the second TCI state, and the third TCI state indicated in the information is applied to a specific channel for the certain cell, controls at least one of transmission and reception of the specific channel.

7. The terminal according to claim 2, wherein
the receiving section receives a Medium Access Control Control Element (MAC CE) including a field indicating whether to change the serving cell, and
the control section judges, on the basis of the field, whether to change the serving cell to the certain cell.

8. The terminal according to claim 2, wherein
the control section changes a configuration of the serving cell to a configuration of the certain cell on the basis of a configuration received with higher layer signaling.

9. The terminal according to claim 3, wherein
the control section changes a configuration of the serving cell to a configuration of the certain cell on the basis of a configuration received with higher layer signaling.
